(19) United States
(12) Patent Application Publication
(10) Pub. No.: US 2024/0251270 A1
(43) Pub. Date: Jul. 25, 2024

(54) MINIMIZATION OF DRIVE TIME FOR WIRELESS COMMUNICATION INCLUDING SIDELINK

(71) Applicant: QUALCOMM Incorporated, San Diego, CA (US)

(72) Inventors: Shankar KRISHNAN, San Diego, CA (US); Karthika PALADUGU, Hyderabad (IN); Peng CHENG, Beijing (CN); Dan VASSILOVSKI, Del Mar, CA (US); Hong CHENG, Basking Ridge, NJ (US); Gavin Bernard HORN, La Jolla, CA (US); Rajeev KUMAR, San Diego, CA (US); Xipeng ZHU, San Diego, CA (US); Ozcan OZTURK, San Diego, CA (US); Aziz GHOLMIEH, Del Mar, CA (US)

(21) Appl. No.: 18/293,331

(22) PCT Filed: Oct. 1, 2021
(86) PCT No.: PCT/CN2021/122486

§ 371 Date: Jan. 29, 2024

(51) Int. Cl. H04W 24/10; H04W 76/27

(52) U.S. Cl. CPC H04W 24/10; H04W 76/27

(57) ABSTRACT

A relay device receives, from the base station, a configuration for minimization of drive test (MDT) measurements associated with sidelink communication and transmits a report of the MDT measurements to the base station based on the configuration. The relay device may transmit, to a second UE, a configuration for logged MDT measurements associated with sidelink communication. The relay may receive an availability indication of logged MDT measurements from the second UE, transmit a request for the logged MDT measurements to the second UE, and receive the logged MDT measurements from the second UE over sidelink. A remote device receives, in a sidelink message from a relay device, a configuration for MDT measurements of sidelink communication and transmits the MDT measurements to the relay device.

### TECHNICAL FIELD

The present disclosure relates generally to communication systems, and more particularly, to measurement and reporting of metrics in connection with wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a relay device. The apparatus receives, from the base station, a configuration for minimization of drive test (MDT) measurements associated with sidelink communication and transmits a report of the MDT measurements to the base station based on the configuration.

In another aspect of the disclosure, a method, a computer-readable medium, and an apparatus are provided for wireless communication at a first user equipment (UE). The apparatus transmits, to a second UE, a configuration for logged MDT measurements associated with sidelink communication. The apparatus receives an availability indication of logged MDT measurements from the second UE, transmits a request for the logged MDT measurements to the second UE, and receives the logged MDT measurements from the second UE over sidelink.

In an aspect of the disclosure, a method, a computer-readable medium, and an apparatus are provided for wireless communication at a remote device. The apparatus receives, in a sidelink message from a relay device, a configuration for MDT measurements of sidelink communication. The apparatus transmits the MDT measurements to the relay device.

In an aspect of the disclosure, a method, a computer-readable medium, and an apparatus are provided for wireless communication at a base station. The apparatus transmits a configuration for MDT measurements of sidelink communication for at least one of a relay device or a remote device served by the relay device. The apparatus receives the MDT measurements from the at least one of the relay device or the remote device based on the configuration.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 illustrates example aspects of a sidelink slot structure.

FIG. 5 illustrates an example of a UE-to-network operation.

FIG. 6 is an example communication flow including the configuration and reporting of MDT measurements for sidelink, in accordance with aspects presented herein.

FIG. 7 is an example communication flow including the configuration and reporting of MDT measurements for sidelink, in accordance with aspects presented herein.

FIGS. 8A and 8B are example communications including the configuration and reporting of MDT measurements for sidelink, in accordance with aspects presented herein.

FIGS. 9-13 illustrates various aspects of measuring delay for inclusion in MDT.

FIG. 14 is an example communication flow including the configuration and reporting of MDT measurements for sidelink, in accordance with aspects presented herein.

FIG. 15 is an example communication flow including the configuration and reporting of MDT measurements for sidelink, in accordance with aspects presented herein.

FIGS. 16A and 16B are flowcharts of methods of wireless communication at a relay device in accordance with aspects presented herein.

FIG. 17 is a flowchart of a method of wireless communication at a wireless device in accordance with aspects presented herein.

FIG. 18 is a diagram illustrating an example of a hardware implementation for an example apparatus that may be configured to perform aspects of the method in FIG. 16A, 16B, or 17.

FIGS. 19A and 19B are flowcharts of methods of wireless communication at a remote device in accordance with aspects presented herein.

FIG. 20 is a diagram illustrating an example of a hardware implementation for an example apparatus that may be configured to perform aspects of the method in FIG. 19A or 19B.

FIG. 21A and 21B are flowcharts methods of wireless communication at a base station in accordance with aspects presented herein.

FIG. 22 is a diagram illustrating an example of a hardware implementation for an example apparatus that may be configured to perform aspects of the method in FIG. 21A or 21B.

### DETAILED DESCRIPTION

A network may perform measurements regarding traffic, which may be referred to herein as traffic verification statistics or quality of service (QOS) statistics. Examples of traffic verification statistics include UE throughput, a packet loss rate, a packet discard rate, a Uu loss rate, a packet drop rate, or a PDCP service data unit (SDU) drop rate, among other examples. The UE throughput may include a downlink throughput and/or an uplink throughput. The traffic verification statistics may be based on traffic aggregation or traffic duplication, for example. In some aspects, a network may configure a UE to collect and report such measurements to the network. As an example, the network may configure the UE to collect and report MDT measurements, e.g., including MDT data collected over time. In some aspects, a self-organizing network (SON) may use such measurements to plan, configure, manager, optimize, heal, or adjust itself. For example, a base station may self-adjust or self-optimize parameters and behavior in response to observed/reported network performance and/or radio conditions. As one, non-limiting example such measurements may enable a new base station to be added to a network in a plug-and-play manner in which the base station may be recognized, registered, and managed based on such measurements. For example, neighboring base stations may adjust one or more parameters (e.g., transmission power, spatial direction of transmissions, timing, etc.) in response to detection of the new base station. Some UEs may support communication with a base station and communication directly with other UEs based on sidelink. Aspects presented herein enable a base station, or a UE, to obtain MDT measurements for sidelink communication. The measurements may enable a network, network device, or UE to plan, configure, manage, optimize, or adjust one or more wireless communication parameters to account for such sidelink communication. In some aspects, a base station may configure a UE or an IAB node to collect and report sidelink MDT measurements. In some aspects, a UE may configure another UE to collect and report sidelink MDT measurements.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically crasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described aspects may occur. Implementations may range a spectrum from chip-level or modular components to non-modular, non-chip-level implementations and further to aggregate, distributed, or original equipment manufacturer (OEM) devices or systems incorporating one or more aspects of the described aspects. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, aggregated or disaggregated components, end-user devices, etc. of varying sizes, shapes, and constitution.

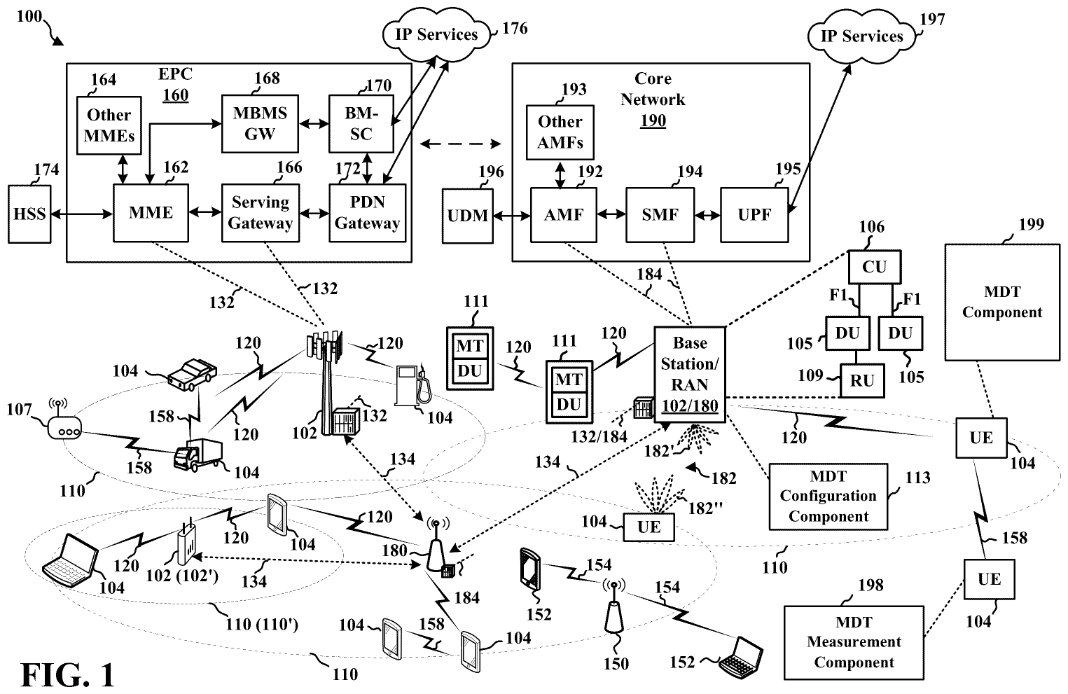

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

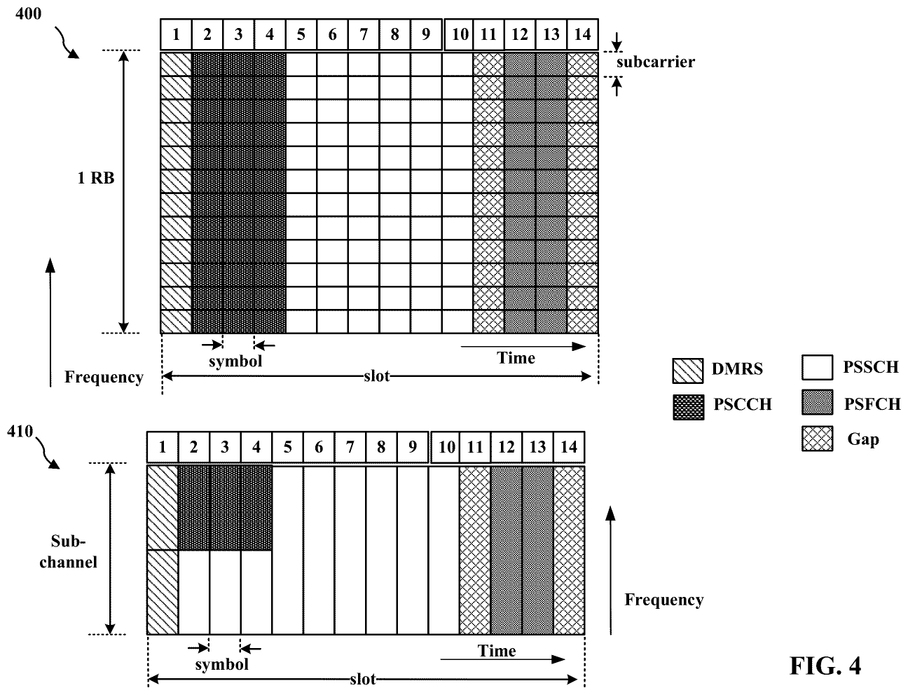

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSc), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 4. Although the following description, including the example slot structure of FIG. 4, may provide examples for sidelink communication in connection with 5G NR, the concepts described herein may be applicable to other similar areas, such as LTE, LTE-A, CDMA, GSM, and other wireless technologies.

In some aspects, a first UE may transmit communication for a base station to a second UE over sidelink for relay by the second UE to the base station over an access link, e.g., Uu interface. In some aspects, the operation may be referred to as a UE-to-network relay. The relay may be based on a layer 2 (L2) relay or a layer 3 (L3) relay.

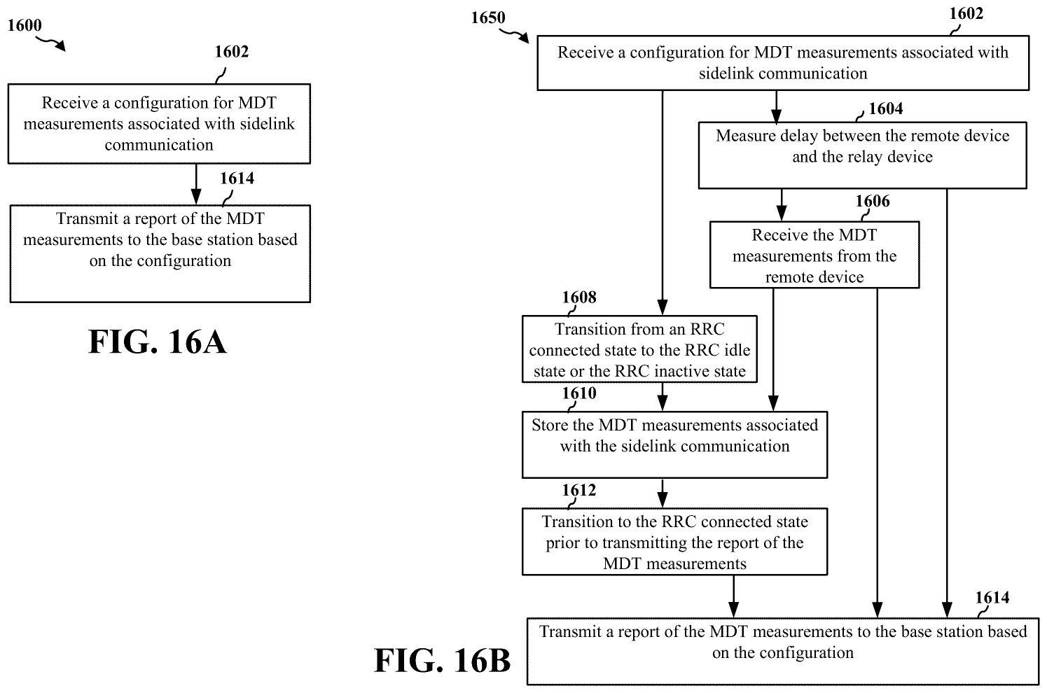

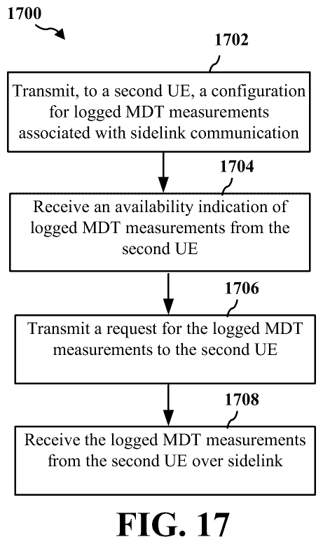

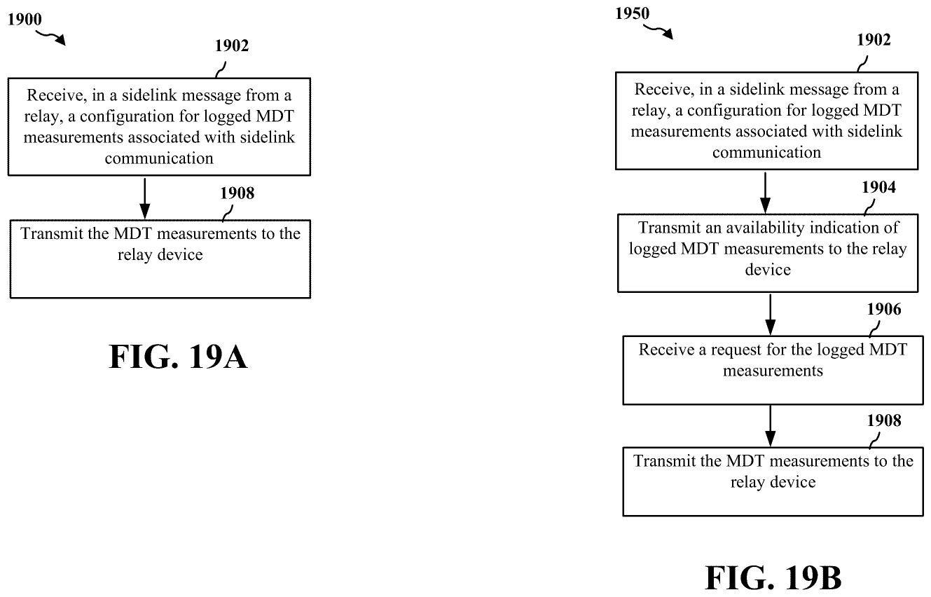

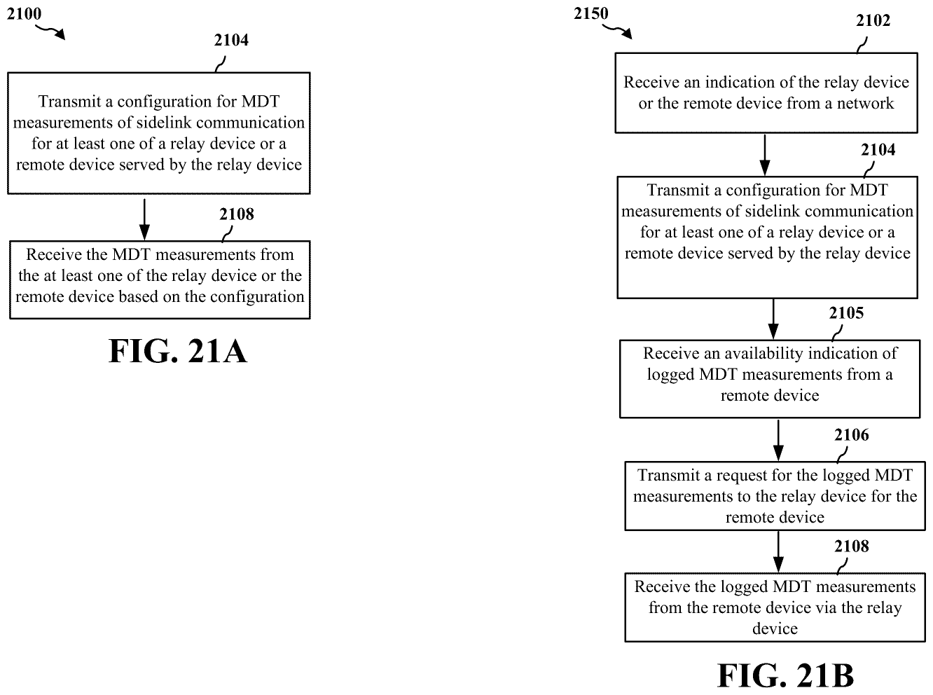

A UE 104 may include an MDT component 199 that is configured to receive, from a base station 102/180, a configuration for MDT measurements associated with sidelink communication and to transmit a report of the MDT measurements to the base station based on the configuration, e.g., as described in connection with FIG. 16A and/or 16B. In some aspects, the MDT component 199 may be configured to transmit, to a second UE, a configuration for logged MDT measurements associated with sidelink communication, e.g., as described in connection with FIG. 17. A UE 104 may be configured to operate as a relay UE and/or a remote UE. In some aspects, the UE may include an MDT measurement component 198 may be configured to receive, in a sidelink message from a second UE, a configuration for MDT measurements of sidelink communication and to transmit the MDT measurements to the second UE, e.g., as described in connection with FIG. 19A or 19B. In some aspects, a base station 102 or 180 may include an MDT configuration component 113 configured to transmit a configuration for MDT measurements of sidelink communication for at least one of a relay UE or a remote UE served by the relay UE, and receive the MDT measurements from the at least one of the relay UE or the remote UE based on the configuration, e.g., as described in connection with FIG. 21A or 21B.

A base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184 (e.g., an Xn interface), and the third backhaul links 134 may be wired or wireless.

In some aspects, a base station 102 or 180 may be referred as a RAN and may include aggregated or disaggregated components. As an example of a disaggregated RAN, a base station may include a central unit (CU) 106, one or more distributed units (DU) 105, and/or one or more remote units (RU) 109, as illustrated in FIG. 1. A RAN may be disaggregated with a split between an RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs 105 may be connected via an F1 interface. A DU 105 and an RU 109 may be connected via a fronthaul interface. A connection between the CU 106 and a DU 105 may be referred to as a midhaul, and a connection between a DU 105 and an RU 109 may be referred to as a fronthaul. The connection between the CU 106 and the core network may be referred to as the backhaul. The RAN may be based on a functional split between various components of the RAN, e.g., between the CU 106, the DU 105, or the RU 109. The CU may be configured to perform one or more aspects of a wireless communication protocol, e.g., handling one or more layers of a protocol stack, and the DU(s) may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. A CU 106 may host higher layer functions, e.g., above the RLC layer, such as a service data adaptation protocol (SDAP) layer, a packet data convergence protocol (PDCP) layer. In other implementations, the split between the layer functions provided by the CU, DU, or RU may be different.

An access network may include one or more integrated access and backhaul (IAB) nodes 111 that exchange wireless communication with a UE 104 or other IAB node 111 to provide access and backhaul to a core network. In an IAB network of multiple IAB nodes, an anchor node may be referred to as an IAB donor. The IAB donor may be a base station 102 or 180 that provides access to a core network 190 or EPC 160 and/or control to one or more IAB nodes 111. The IAB donor may include a CU 106 and a DU 105. IAB nodes 111 may include a DU 105 and a mobile termination (MT). The DU 105 of an IAB node 111 may operate as a parent node, and the MT may operate as a child node.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FRI (410 MHZ-7.125 GHZ) and FR2 (24.25 GHz-52.6 GHz). Although a portion of FRI is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FRI characteristics and/or FR2 characteristics, and thus may effectively extend features of FRI and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (52.6 GHZ - 114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

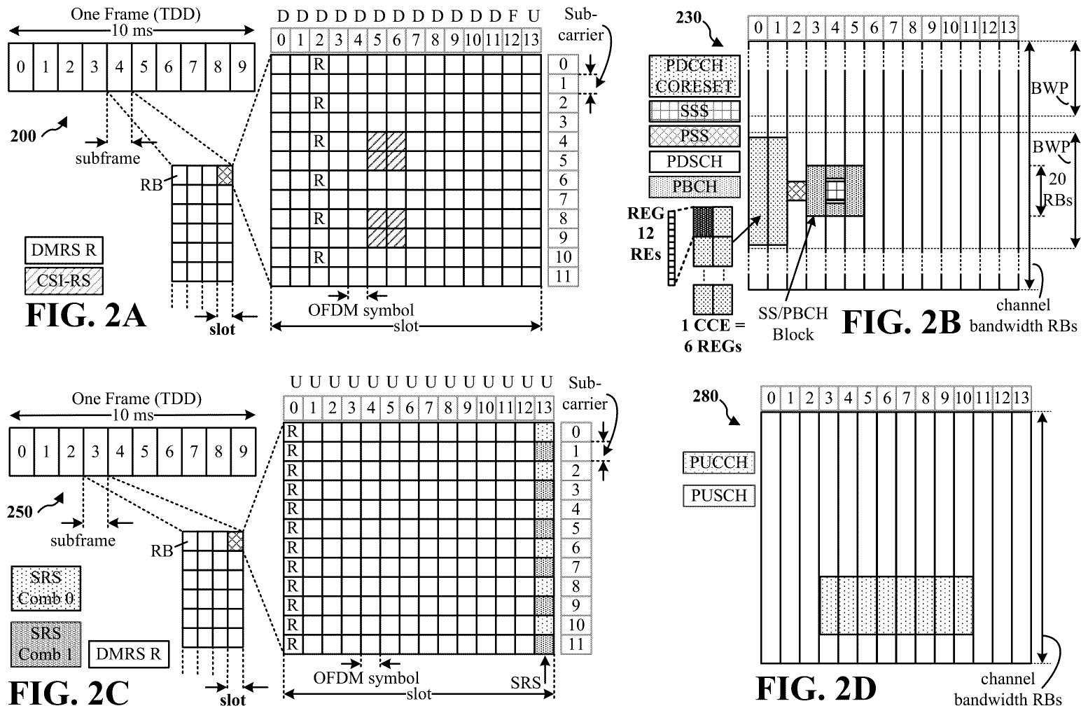

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

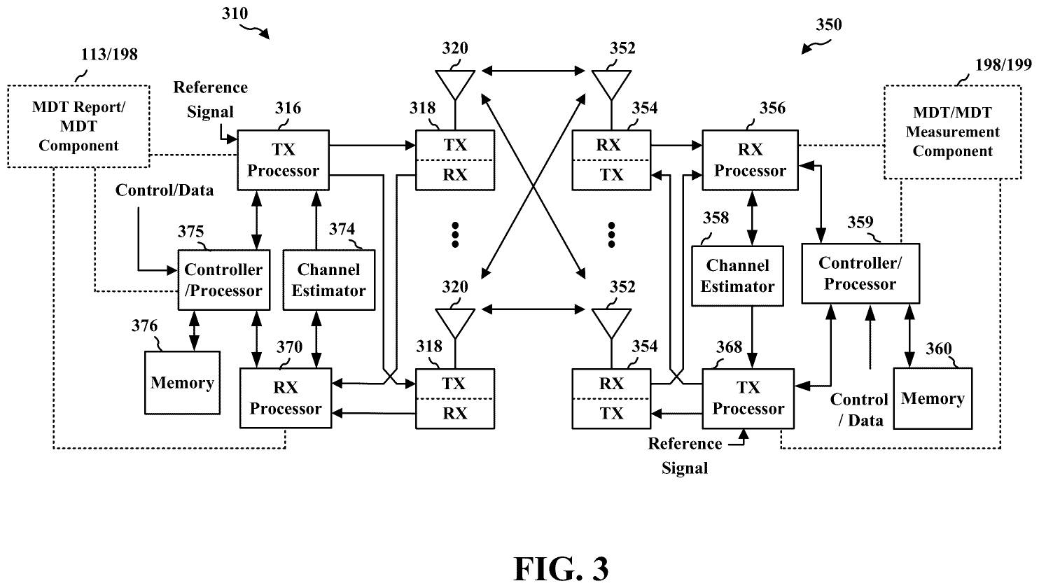

FIG. 3 is a block diagram of a first wireless communication device 310 in communication with a second wireless communication device 350. In some examples, the devices 310 and 350 may communicate based on sidelink, e.g., and may use a PC5 interface. The devices 310 and 350 may correspond to UEs, in some aspects. In other examples, the device 310 may be a base station 102 and the device 350 may be a UE 104. The communication between the devices may be over an access link, e.g., based on a Uu interface. Packets may be provided to a controller/processor 375 that implements layer 3 and layer 2 functionality. Layer 3includes a radio resource control (RRC) layer, and layer 2 includes a packet data convergence protocol (PDCP) layer, a radio link control (RLC) layer, and a medium access control (MAC) layer.

The controller/processor 375 may provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318 TX. Each transmitter 318 TX may modulate a radio frequency (RF) carrier with a respective spatial stream for transmission.

At the device 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the device 310. These soft decisions may be based on channel estimates computed by the channel estimator 358. The soft decisions are then decoded and deinterleaved to recover the data and control signals that were originally transmitted by the device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the device 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the device 310 in a manner similar to that described in connection with the receiver function at the device 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the device 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 and/or the TX processor 316, the RX processor 370, and the controller/processor 375 may be configured to perform aspects in connection with the MDT component 199, the MDT measurement component 198 or the MDT configuration component 113 of FIG. 1.

FIG. 4 includes diagrams 400 and 410 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 4 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 400 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may include 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 410 in FIG. 4 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 4, some of the REs may include control information in PSCCH and some REs may include demodulation RS (DMRS). At least one symbol may be used for feedback. FIG. 4 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may include the data message described herein. The position of any of the data, DMRS, SCI, feedback, gap symbols, and/or LBT symbols may be different than the example illustrated in FIG. 4. Multiple slots may be aggregated together in some aspects.

A network may perform measurements regarding traffic, which may be referred to herein as traffic verification statistics or quality of service (QOS) statistics. Examples of traffic verification statistics include UE throughput, a packet loss rate, a packet discard rate, a Uu loss rate, a packet drop rate, or a PDCP service data unit (SDU) drop rate, among other examples. The UE throughput may include a downlink throughput and/or an uplink throughput. The traffic verification statistics may be based on traffic aggregation or traffic duplication, for example. In some aspects, a network may configure a UE to collect and report such measurements to the network. As an example, the network may configure the UE to collect and report MDT measurements, e.g., including MDT data collected over time. In some aspects, a self-organizing network (SON) may use such measurements to plan, configure, manager, optimize, heal, or adjust itself. For example, a base station may self-adjust or self-optimize parameters and behavior in response to observed/reported network performance and/or radio conditions. As one, non-limiting example such measurements may enable a new base station to be added to a network in a plug-and-play manner in which the base station may be recognized, registered, and managed based on such measurements. For example, neighboring base stations may adjust one or more parameters (e.g., transmission power, spatial direction of transmissions, timing, etc.) in response to detection of the new base station. Some UEs may support communication with a base station and communication directly with other UEs based on sidelink. Aspects presented herein provide for a base station or UE to configure a UE to collect and report sidelink MDT measurements.

An example UE throughput measurement may be referred to as an M5 measurement, in some examples. M5 measurements may be obtained for both downlink and uplink scheduled UE Internet Protocol (IP) throughput. The UE throughput within a measurement period is determined as a total downlink data burst transmitted within a measurement period divided by the time used for the transmission of the data burst within a measurement period. For example, the UE throughput within a measurement period may be determined as:

$$If \sum Thp Time Dl > 0 ,$$

$$\frac{\sum ThpVolDl}{\sum Thp Time Dl} \times 1000 [ kbits / s ]$$

$$If \sum Thp Time Dl = 0 ,$$

$$0 [ kbits / s ]$$

In this example, ThpTimeD1 corresponds to the measurement time (e.g., the time to transmit the downlink data burst) and ThpVolD1 corresponds to total downlink data burst, e.g., the amount of data transmitted in the data burst. For one RAT, such as LTE, the UE throughput may be determined per data radio bearer (DRB), per UE, and per UE for downlink and for uplink. The reference point may be a medium access control (MAC) upper service access point (SAP). The throughput may be determined of PDCP SDUs that are transmitted in multiple transmission time intervals (TTIs). In another RAT, such as NR, the throughput may be determined per DRB, per UE, and per UE for downlink and uplink. The reference point may be an upper MAC SAP. For NR, an average downlink/uplink UE throughout at a base station may be determined for throughput of data bursts taking multiple slots for transmission with the data burst being measured in terms of RLC SDUs. A distribution of downlink/uplink UE throughout for the base station may be determined, e.g., for NR. The throughput distribution may be determined for the data burst that is transmitted over multiple slots with the data burst being measured in terms of RLC SDUs.

As another example of a traffic verification statistic, the network may determine a packet loss rate measurement. The packet loss rate may be referred to as an M7 measurement in some examples. A packet loss measurement may be determined per a measurement period for LTE or for NR.

For example, in LTE, a packet loss rate may be determined per QoS class identifier (QCI) or bearer (e.g., downlink or uplink). The reference point may be a PDCP upper SAP. The packet discard rate may be determined in the downlink as 10⁶×a fraction of packets (PDCP SDU) dropped at the PDCP, RLC, or MAC due to a configuration, traffic measurement, etc., other than a handover. The measurement may capture the statistics for the packets for which no part has been transmitted over the air. A packet Uu loss rate may be determined for downlink traffic based on as 10⁶×a fraction of packets (PDCP SDU) not received by a base station PDCP upper layer. For example, in NR, the packet loss rate may be determined per DRB. A downlink PDCP SDU drop rate at a base station centralized unit (CU) user plane (UP) (e.g., in a gNB-CU-UP) as 10⁶×a fraction of packets (PDCP SDU) dropped due to a configuration, traffic measurement in the base station-CU-UP (e.g., a gNB-CU-UP). A base station-CU may include RRC, SDAP, and PDCP. A base station-DU may include RLC, MAC, and PHY layers. A dropped packet may be a packet whose context is removed from the base station-CU-UP without any part of the packet having been transmitted on the F1-U, Xn-U, or X2-U interface. A downlink packet drop rate may be determined, e.g., at a base station-distributed unit (DU) (e.g., gNB-DU), as 10⁶×a fraction of packets (RLC SDU) dropped at the downlink (e.g., RLC or MAC) due to a configuration, traffic measurement, etc. in the base station-DU. A dropped packet may be a packet whose context is removed from the base station-DU without any part of the packet having been transmitted on the air interface. A packet Uu loss rate in the downlink may be determined per DRB per UE, e.g., as 10⁶×Uu packet (e.g., RLC SDU) loss rate in the downlink per DRB per UE. An uplink PDCP SDU loss rate may be determined as 10⁶×a fraction of packets (PDCP SDU) not received by the base station PDCP upper layer.

A wireless device may support communication with a network entity over a connection based on a first radio access technology (RAT) (e.g., a Uu interface) and may support communication with another wireless device over a connection based on a different RAT (e.g., a PC5 interface, a Bluetooth low energy (BLE) interface, a WiFi-D interface, a WiFi interface, or a bluetooth (BL) regular interface, etc.). In some circumstances, the wireless device may not be able to reach the network entity using the Uu interface or may determine that the Uu interface is not suitable for current traffic criteria.

Aspects presented herein enable the wireless device to establish a local connection with the second wireless device (e.g., based on the PC5 interface, the BLE interface, the WiFi-D interface, WiFi interface, the BL interface, etc.) to relay communication between the first wireless device and the network entity. The local connection may be a remote connection that is established based on a discovery procedure of the RAT of the local connection and may be managed by the second wireless device rather than the network entity. Aspects presented herein enable multiple subscriptions (e.g., of the first wireless device and the second wireless device) to share a single connection with the network entity. The second subscription may be hosted remotely on the first wireless device as a tethered device. Each subscription may be associated with a separate radio resource control (RRC) instance at the control unit (CU) of the network entity, e.g., a base station. Each RRC instance may be associated with a separate security context and corresponding data context.

The network entity may configure the second wireless device (which may be referred to as a relay device) with a radio link control (RLC) channel for one or more remote device signaling radio bearers (SRBs) and an RLC channel for one or more remote device data radio bearers (DRBs). For example, the second wireless device may act as a relay for multiple user equipment (UEs), and the network entity may configure the second wireless device with an individual RLC channel for an SRB and an individual RLC channel for a DRB for each of the UEs.

The first wireless device may provide capability information to the network entity, e.g., indicating the type of RAT of the local connection between the first wireless device and the second wireless device and/or indicating a type of relay that the first wireless device supports. For example, the first wireless device may indicate whether it supports a first type of layer 2 (L2) relay in which the connection between the first wireless device and the second wireless device is configured by the network entity or a second type of L2 relay in which the connection between the first wireless device and the second wireless device is controlled locally.

A wireless device may support communication with a network entity over a connection based on a first RAT (e.g., a Uu interface) and may support communication with another wireless device over a connection based on a different RAT (e.g., a sidelink interface, a BLE interface, a WiFi-D interface, a WiFi interface, or a BL regular interface, etc.). In some aspects, the wireless device may be another UE having a reduced capability. In non-limiting examples, the wireless device may be a wearable, a sensor, etc., which may be capable of establishing a Uu connection with a network. In some aspects, the wireless device may not be able to reach the network entity using the Uu interface or may determine that the Uu interface is not suitable for current traffic criteria. In some aspects, the suitability may be based on a quality of a Uu connection. As an example, the wireless device may move to a location with reduced coverage by the network. The wireless device may establish a local connection with a second wireless device. As an example, a UE may establish a sidelink connection with a second UE to relay communication between the wireless device and the network entity, e.g., a base station.

The local connection may be referred to as a remote connection that is established based on a discovery procedure of the RAT of the local connection and may be managed by the second wireless device or the first wireless device itself rather than the network entity. Aspects presented herein enable multiple subscriptions (e.g., a subscription of the multiple UEs) to share a single connection with the network entity. The second subscription may be hosted remotely on the remote UE as a tethered device, e.g., that is tethered to the relay UE using the local RAT. Each subscription may be associated with a separate RRC instance at the CU of the network entity, e.g., a base station. Each RRC instance may be associated with a separate security context (e.g., an access stratum (AS) context and a non-access stratum (NAs) context). Each RRC instance may be associated with a separate control plane context at central unit control plane (CU-CP) and a user plane context at central unit user plane (CU-UP). The separate RRC instances help the network to distinguish between the subscription of the relay UE and the remote device UE.

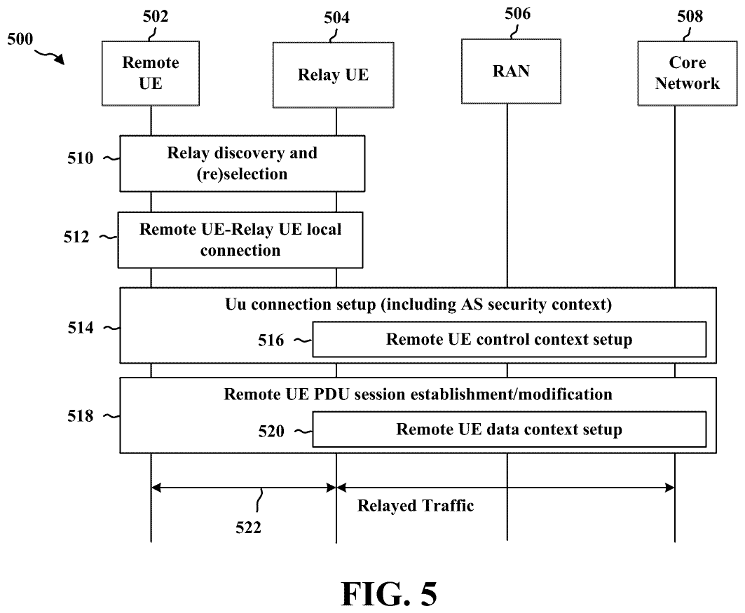

FIG. 5 illustrates an example communication flow 500 between a remote UE 502, a relay UE 504, a RAN 506, and a core network 508 to establish a connection between the remote UE 502 and the network (e.g., the RAN 506 and/or core network 508). The remote UE 502 and the relay UE may correspond to UEs 104 in FIG. 1. At 510, the remote UE 502 and relay UE 504 discovery each other using a discovery procedure based on a locate RAT (e.g., PC5, WiFi, BLE, BL, etc.). Although illustrated as a single step, there may be multiple steps involved in the discovery or reselection procedure 510. For example, the remote UE 502 may discover one or more relay UEs within a range of the remote UE 502. The remote UE 502 may discovery the remote UE 502 based on a discovery message transmitted by the remote UE 502. In some examples, the remote UE may advertise a capability to provide a relay service, e.g., a second type of L2 relay. The second type of L2 relay may be referred to as a remote connection in some examples. The second type of L2 relay may be controlled or managed locally, e.g., by the relay UE and/or the wireless device. For example, the connection between the remote UE 502 and the relay UE 504 may be managed by the remote UE 502 and the relay UE 504 without configuration by a network (e.g., RAN 506 or core network 508). The remote UE 502 and/or the relay UE 504 may provide additional information in the discovery process.

At 512, after discovering the relay UE 504, the remote UE 502 and the remote UE may establish a local connection (e.g., a PC5, WiFi, BLE, BL, or other non-Uu connection). The relay UE 504 and the remote UE 502 may establish the connection, at 512, without control from the RAN 506, e.g., using a local RAT connection setup procedure.

At 514, the remote UE establishes one or more of an AS connection with a network entity (e.g., RAN 506 or core network 508) via the relay UE 504. The remote UE 502 sends communication for the connection setup to the relay UE 504 that the relay UE 504 transmits the communication to the network. The network sends the connection setup communication for the remote UE 502 to the relay UE 504. The network configures, at the relay UE 504, a control context setup for the remote UE, at 516. At 518, the network establishes or modifies a PDU session for the remote UE 502, including configuring, at the relay UE 504, a data context set up for the remote UE, at 520.

Thus, the remote UE establishes an AS connection, NAS connection, and PDU session(s) with the network (e.g., the RAN 506 and/or core network 508) via the relay UE 504 using the local connection established at 512. The network configures the remote UE control and data context (e.g., for Uu control and data) at the relay UE 504.

Then, the remote UE 502 and the network (e.g., RAN 506 or core network 508) may exchange traffic 522 via the relay UE 504 for the PDU session configured for the remote UE 502.

The remote UE may determine to connect to a relay UE for various reasons. In some examples, the remote UE 502 may determine that the network is not reachable with a direct Uu connection. In other examples, the remote UE 502 may be capable of establishing a Uu connection with the network yet may determine that the direct connection between the remote UE and the network is not suitable for a particular type of traffic that the remote UE will exchange with the network. In response, the remote UE 502 may then search for, or attempt to discover, a relay UE 504 capable of providing a remote connection relay service for the wireless device (e.g., remote UE 502).

After selecting the relay UE 504 and establishing the connection, at 512, the remote UE may continue to monitor reselection criteria based on the local RAT selection procedure. For example, the remote UE 502 and/or the relay UE 504 may be mobile, and the coverage that the relay UE 504 provides under the local RAT may vary. At times, the remote UE 502 may discover a different relay UE 504 that meets the reselection criteria for the local RAT and may reselect to the other relay UE 504.

FIG. 5 illustrates the relay UE 504 providing a single hop to the network for the tethered connection with the remote UE 502. Although FIG. 5 illustrates a single remote UE 502, in some examples, the relay UE 504 may provide a relay service to multiple remote devices over the local RAT. In some examples, the relay UE may support up to a particular number of remote UEs. The relay UE 504 may support a dedicated Uu radio link control (RLC) channel for each remote UE. The relay UE and the base station (e.g., RAN 506) may support the relaying to the remote UE 502 without an adaptation layer, in some aspects. The relay UE may use a one-to-one mapping between the Uu RLC channel configured for the remote UE at the relay UE and the local RAT connection to the remote UE. For example, the relay UE 504 may relay traffic from the base station to the remote UE without identifiers for bearer mapping. The remote UE data may be sent over Uu signaling radio bearers (SRBs) and data radio bearers (DRBs). On the local link between the remote UE 502 and the relay UE 504, the relay UE 504 may manage the local connection quality of service (QoS) and context. On the Uu link between the relay UE 504 and the network, the relaying RLC channels and QoS may be configured by the base station based on the remote UE's DRBs. The network may send the remote UE 502 user plane data after performing the connection setup, at 514 and PDU session setup, at 518.

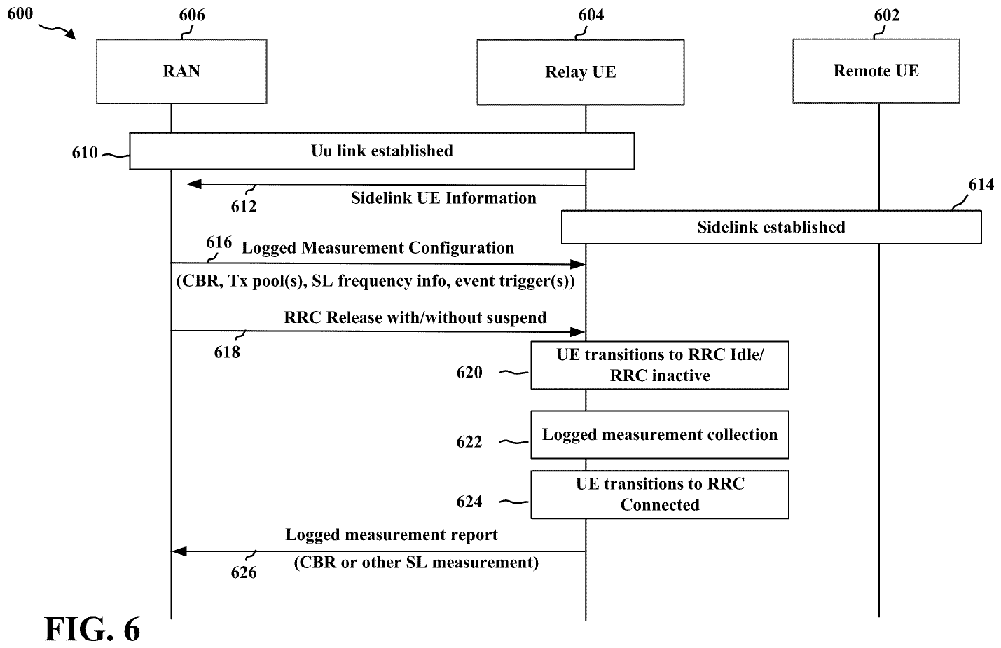

FIG. 6 illustrates an example communication flow 600 that includes logged MDT measurements that a relay UE provides to a network. The aspects described in connection with FIG. 6 enable a UE to collect MDT measurements regarding sidelink while in an RRC idle state or an RRC inactive state using a logged MDT procedure. As one non-limiting example, the UE may collect channel busy ratio (CBR) measurements while in the RRC idle or RRC inactive state, and may report the logged CBR measurements to the network when the UE transitions to an RRC connected state. FIG. 6 illustrates a RAN 606 having a Uu link established, at 610, with a UE 604 (which may be referred to as a relay UE). The RAN 606 and the UE 604 may exchange one or more messages as a part of establishing the Uu link, at 610. At 612, the UE 604 may provide sidelink information, e.g., sidelink measurements such as CBR, to the RAN 606. The UE 604 may establish a sidelink with the UE 602 and may relay communication from the UE 602 to the RAN 606. In the description of FIG. 6, the UE 604 may be referred to interchangeably as a “relay UE”, and the UE 602 may be referred to interchangeably as a “remote UE”. The relay UE 604 may correspond to the relay UE 504, and the remote UE 602 may correspond to the remote UE 502 in FIG. 5. The establishment of the sidelink, at 614, may include the exchange of one or more sidelink messages between the UEs 602 and 604, e.g., including any of the messages described in connection with FIG. 5.

At 616, the RAN 606 may transmit a logged MDT measurement configuration to the relay UE 604 to apply for collecting sidelink measurements when the relay UE is in an RRC idle or RRC inactive state. The logged measurement configuration may indicate for the relay UE 604 to log CBR measurements. The logged measurement configuration may indicate one or more sidelink transmission pools for which the relay UE is to perform the logged MDT measurements. The logged measurement configuration may indicate sidelink frequency information indicating particular frequencies for which the relay UE is to perform the logged MDT measurements. As an example, the configuration may indicate a sidelink common frequency configuration (e.g., SL-FreqConfigCommon) that includes a sidelink (SL) point A, a sidelink SSB, a sidelink bandwidth part (BWP), among other aspects. SL point A refers to a sidelink frequency reference point, which may be referred to as a sidelink absolute frequency point A. Sidelink point A may refer, e.g., to an absolute frequency position of a reference resource block, e.g., a common RB 0, having a lowest carrier referred to as Point A.

The logged measurement configuration may indicate one or more event triggers to trigger the relay UE 604 to collect logged MDT measurements to the RAN. An example event trigger may include a serving relay's SL-RSRP being below a threshold RSRP. If the relay UE 604 has a SL-RSRP that falls below the threshold, the relay UE 604 may respond by measuring and storing the logged MDT measurements, e.g., as illustrated at 622. Another example of an event trigger is a Uu link between the UE and the RAN being out-of-coverage (e.g., not meeting a threshold metric for coverage), and the UE being within coverage of a relay UE such as an L2 relay UE, and L3 relay UE, a UE-to-UE (U2U) relay, etc. As an example, if the UE 604 is out of coverage of the RAN, but establishes a relay connection with a different UE that has a connection with the RAN, the UE 604 may start collecting and storing the logged MDT measurements. Another example of an event trigger is a Uu link between the UE and the RAN being out-of-coverage, and the UE being out-of-coverage for sidelink connections. As an example, if the UE 604 is out of coverage of the RAN and sidelink, the UE 604 may start collecting and storing the logged MDT measurements. The addition of a trigger event may enable the UE 604 to log sidelink MDT measurements at particular times rather than constantly or periodically collecting the measurements. The targeted, or triggered, collection of MDT measurements may assist the network while reducing battery and storage use at the UE.

After providing the UE 604 with the logged MDT measurement configuration, the RAN 606 may transmit an RRC release message 618, and the UE 604 may transition to an RRC idle state or an RRC inactive state, at 620, in response to the RRC release message 618. While in the RRC idle/inactive state, the UE 604 measurements, collects, and stores the configured sidelink MDT measurements. For example, the UE 604 measures and stores the configured type of measurement(s) on the indicated sidelink transmission pool(s), the indicated sidelink frequency(s), and/or in response to the occurrence of at least one configured event trigger. At some point, the UE 604 transitions to an RRC connected state, at 624, with the RAN 606. The transition may occur via a direct path, e.g., based on a Uu link between the UE 604 and the RAN 606, or may be based on an indirect path via a different relay UE, the UE 604 having a sidelink connection to the different UE relay, and the different UE relay having a Uu connection with the RAN 606. In response to transitioning to the RRC connected state with the RAN 606, or after transitioning to RRC connected, the UE 604 transmits a logged measurement report 626, to the RAN providing the stored MDT measurements that the UE 604 collected at 622. If the RRC connection is established/reestablished/resumed via a relay, the UE 604 may transmit the logged measurement report 626 via the relay.

In some aspects, the RAN may select one or more UEs for performing MDT during management based MDT. As an example, a RAN 606 may have or receive a list of one or more UEs (each having a UE ID), a list of relay UE IDs, and/or a list of source and/or destination IDs in a logged MDT configuration. The list(s) may be provided by the core network. The list may be included by an OAM. The RAN 606 may select UEs from the list(s) to perform logged MDT measurements, and may transmit the logged measurement configuration to a UE based on the UE being included in at least one list.

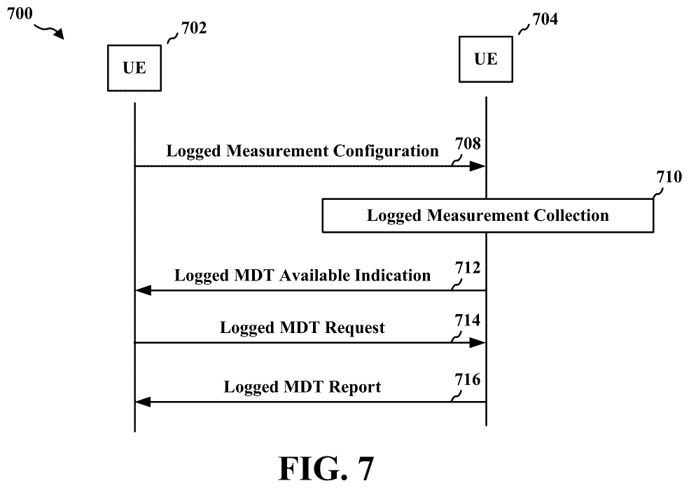

FIG. 7 illustrates an example communication flow 700 between a first UE 702 and a second UE 704. For example, the UEs 702 and 704 may exchange transmissions based on sidelink. The aspects described in connection with FIG. 7 enable a mechanism to configure and collect sidelink measurements from a peer UE. In some aspects, the configuration and collection may be performed autonomously, e.g., independent of control/direction from a base station, such as without a network configuration. The UE 702 may be triggered to send the logged measurement configuration to the UE 704. In some aspects, the trigger may be network assisted, e.g., upon receipt of a configuration from a RAN or upon receipt of an indication from the RAN. In other aspects, the trigger may be an autonomous trigger without a network configuration/control. In some aspects, the UEs 702 and 704 may exchange particular sidelink messages, e.g., sidelink RRC messages (e.g., PC5 RRC message(s)) that are dedicated for logged measurement configuration, requests for logged measurement information, and a logged measurement report. FIG. 7 illustrates that the UE 702 may transmit a logged measurement configuration 708 (e.g., a logged MDT measurement configuration) to the UE 704 over sidelink. In some examples, the configuration message be referred to as a may

LoggedMeasurementConfigurationSidelink message. The configuration, at 708, may include any of the aspects described in connection with 616 in FIG. 6. In response to the configuration, the UE 704 collects and stores the configured sidelink measurements, at 710, which may be referred to as logged measurement collection or logged MDT measurement collection. The collection may include any of the aspects described in connection with 622 in FIG. 6. The UE 704 may transmit an availability message 712 to the UE 702 indicating that logged measurements are available to report to the UE 702. In some aspects, the availability message 712 may be referred to as a logged MDT available indication. In response to the availability indication from the UE 704, the UE 702 may transmit a request 714 for the UE 704 to transmit a logged MDT report of the measurements collected at 710. In some aspects, the request may be included in a UE information request sidelink message (e.g., which may be referred to as a “UEInformationRequestSidelink” message). The request 714 may be in a logged MDT request message. In response to the request 714, the UE 704 may transmit the logged MDT measurements collected at 710. The UE 704 may transmit the measurements in a logged MDT report over sidelink to the UE 702. In some aspects, the report may be included in a UE information response sidelink messages (e.g., which may be referred to as a “UEInformationResponseSidelink” message).

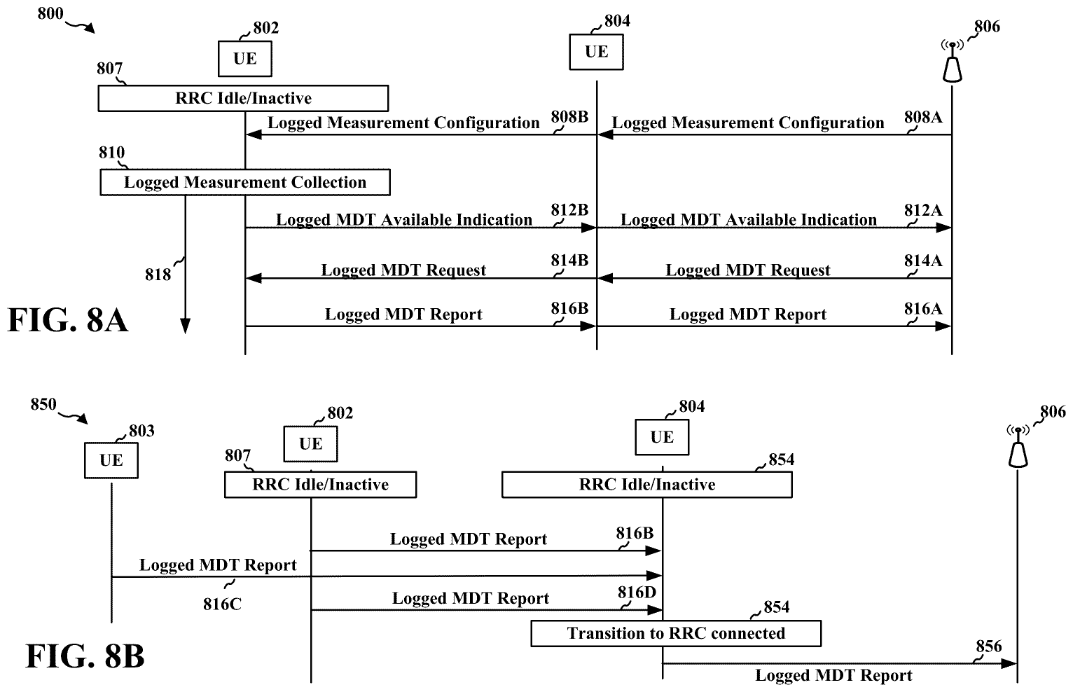

FIG. 8A illustrates an example communication flow 800 between a base station 806, a relay UE 804, and a remote UE 802. Although the example is described for a relay UE and a remote UE to illustrate the concept, the aspects may also be applicable for other types of devices, including IAB nodes and other devices. The remote UE 802 and the relay UE 804 may have a sidelink connection, e.g., as described in connection with FIG. 5 and/or 6. The relay UE 804 may relay messages received from the UE 802 over the sidelink for relay to the base station 806 over a Uu connection between the relay UE 804 and the base station. At 807, the remote UE 802 may be in an RRC idle state or an RRC inactive state with the base station 806 (e.g., RAN) and may have a sidelink connection with the relay UE 804. The base station 806 transmits a logged measurement configuration 808A for the remote UE 802 to the relay UE 804 in a Uu message for relay to the remote UE 802 over sidelink. The relay UE 804 transmits the logged measurement configuration from the base station 806 to the remote UE 802, at 808B. The remote UE 802 then collects (e.g., measures and stores) logged measurements, at 810, according to the configuration and while in the RRC idle/RRC inactive state. The configuration from the base station, at 808A, that is provided to the remote UE at 808B, may include any of the aspects described in connection with 616 in FIG. 6. Similar to the description of the availability indication, request, and report in FIG. 7, the remote UE 802 may transmit an availability indication, at 812B, over sidelink to the relay UE 804 for relay to the base station, at 814A, over a Uu link. The remote UE 802 may report the availability of the logged MDT report in response to a criteria being met, based on a periodic amount of time having lapsed, etc. In response to receipt of the availability indication, at 812A, the base station 806 may transmit a request for a logged MDT report to the relay UE 804 for relay to the UE 602 over sidelink. The relay UE 804 may transmit the logged MDT request to the UE 802 over sidelink. The UE 802 may respond to the request 814B by transmitting the logged MDT measurements, at 816B to the relay UE over sidelink. The relay UE 804 may transmit the received MDT measurements 816B to the base station in a Uu message, at 816A. The report may include any of the aspects described in connection with 626 or 716. In some aspects, the availability indication, request, or report may be exchanged in sidelink RRC messages (e.g., PC5 RRC messages). The logged measurements may include sidelink MDT measurements. As one, non-limiting example, the logged MDT measurements may include logged CBR measurements. As shown by the arrow 818, the UE 802 may continue to perform logged measurement collection even after indicating the availability of logged MDT measurements. The logged MDT configuration and reporting of FIG. 8A via a relay UE enables out-of-coverage UEs (such as the UE 802) that are outside of coverage of a base station to be configured to log MDT measurements for sidelink. The out-of-coverage UEs may be in an RRC idle state or RRC inactive state with the base station, and the base station may configure the idle/inactive UE to perform logged MDT measurements (without transitioning to an RRC connected state) via a relay UE that provides the configuration to the idle/inactive UE via sidelink. The aspects of FIG. 8A also enable an out-of-coverage UE to provide the logged sidelink MDT measurements to the network through the use of a sidelink connection with a relay UE 804 and without transitioning to an RRC connected state with the base station 806. The logged measurement collection at the remote UE may reduce the load on the storage of logged MDT reports at the relay UE 804. The logged measurement configuration of the remote UE may enable the remote UE in an idle/inactive mode to send timely logged MDT information to the network without going to an RRC connected state.

In some aspects, the relay UE 804 may forward the logged MDT report received from the remote UE, at 816B, without storage. For example, the relay UE 804 may be in an RRC connected state (e.g., have an established RRC connection) with the base station 806. The relay of the logged MDT report, at 816A, without storage at the relay UE 804 reduces a potential storage load at the relay UE 804.

In some aspects, the relay UE 804 may include the measurements from the remote UE (received at 816B) in a transparent container for transmission, at 816A, to the base station 806 via a Uu SRB. The Uu SRB may be a new SRB or an additional SRB.

As described in connection with FIG. 8A, the remote UE 802 may remain in the RRC idle or RRC inactive state, and may be configured for logged MDT collection, indicate the availability of logged MDT measurements to a RAN, be requested to provide the logged MDT measurements, and provide the logged MDT measurements to the RAN via the relay UE 804 and without transitioning to an RRC connected state with the RAN.

FIG. 8B illustrates an additional or alternative example aspect in which the relay UE 804 of FIG. 8A may provide a group report of logged MDT measurements from one or more remote UEs. Although the example is described for a relay UE and a remote UE to illustrate the concept, the aspects may also be applicable for other types of devices, including IAB nodes and other devices. The aspects described in connection with FIG. 8A and/or 8B may be performed by a relay UE 804 as an L2 relay or an L3 relay. The communication flow 850 in FIG. 8B may reduce a large signaling overhead and latency of multiple remote UEs reporting logged MDT measurements to a network in response to the relay UE transitioning to an RRC connected state. If each remote UE waits until a relay UE is in an RRC connected state, the transition to the RRC connected state may trigger a significant amount of signaling from multiple UEs as they provide their logged MDT measurements to the relay UE for relay to the network. In contrast, in FIG. 8B, one or more remote UEs may send logged MDT measurements to the relay UE 804 prior to the relay UE transitioning to an RRC connected state, at 854. FIG. 8B illustrates an example in which the remote UE 802 and the remote UE 803 may transmit one or more logged MDT report 816B, 816C, 816D to the relay UE 804 over sidelink while the relay UE is in an RRC idle state or RRC inactive state, as shown at 854. The remote UEs 802 and 803 may transmit the logged MDT reports 816B-D to the relay in sidelink RRC messages (e.g., PC5 RRC messages). The relay UE 804 may store the logged MDT measurements/reports received from the remote UEs until the relay UE 804 transitions to an RRC connected state, at 854, with the base station 806. In response to the entering the RRC connected state, the relay UE 804 may forward the logged MDT measurements/reports to the base station 806, at 856. The relay UE 804 may transmit aggregated measurements from multiple remote UEs, e.g., in a transparent container that the relay UE 804 sends to the base station 806 over a Uu SRB configured for the relay UE 804. The relay UE 804 may transmit the aggregated MDT measurements to the base station 806 with identification information that identifies the individual UEs providing the data samples. For example, the relay UE 804 may provide the logged MDT measurements (e.g., 816B and 816D) from the UE 802 with an identification of the UE 802, and may provide the logged MDT measurements from the UE 803 (e.g., 816C) with an identification of the UE 803. In some aspects, the relay UE 804 may provide the aggregated measurements to the base station without an identification of the individual UEs or without identifying the individual data samples provided by particular remote UEs.

In some aspects, the base station, or a UE, may configure a UE to measure and provide sidelink MDT measurements without storage. The MDT measurement/report without storage may be referred to as immediate MDT measurements/reports, in some aspects, in contrast to logged MDT measurements. For Uu measurements, a base station may configure a UE to measure downlink signal quantities for a serving cell and for intra-frequency/inter-frequency/inter-RAT neighbor cells. The measurements may include cell level and/or beam level measurements of cells, e.g., of NR cells. In some aspects, the measurements may be referred to as M1 measurements. For sidelink M1 measurements, a UE may be configured (either by a base station or another UE) to measure sidelink signal quantity measurements for unicast links. Some non-limiting examples of sidelink quantity measurements include CBR, sidelink RSRP (SL-RSRP), sidelink RSRQ (SL-RSRQ), and sidelink RSSI (SL-RSSI).

In some aspects, a base station may configure a UE to perform measurement of PDCP SDU data volume separately for downlink and uplink. The base station may configure the UE to measure the PDCP SDU data volume per DRB per UE. The measurements may be referred to as M4 measurements, in some examples. For sidelink M4 measurements, a UE may be configured (either by a base station or another UE) to measure a PDCP SDU data volume for sidelink. The M4 sidelink measurement may be per SL DRB and/or per UE. As an example for M4 sidelink measurements, a transmitting UE may compute a SL transmission (Tx) PDCP SDU data volume, e.g., the amount of PDCP SDU bits in the sidelink delivered to the PDCP layer of the transmitting UE. The receiving UE may compute the SL reception (Rx) PDCP SDU data volume, e.g., an amount of PDCP SDU bits in the sidelink delivered from PDCP layer to higher layers of the receiving UE.

In some aspects, a base station may configure a UE to perform measurement of an average UE throughput, and may configure the UE to perform the measurement separately for downlink and uplink, per DRB, and/or per UE. For example, the base station may configure the UE to measure the average UE throughput per DRB per UE and per UE for the downlink. The base station may configure the UE to measure the average UE throughput per DRB per UE and per UE for the uplink. The measurements may be referred to as M5 measurements, in some examples. For sidelink M5 measurements, a UE may be configured (either by a base station or another UE) to measure an average UE throughput for sidelink. The M5 sidelink measurement may be per SL DRB and per UE and may be measured per UE. For the M5 sidelink measurements, a transmitting UE may compute the average UE throughput in sidelink transmission. A receiving UE may compute the average UE throughput in sidelink Rx.

In some aspects, a base station may configure a UE to perform measurement of a packet delay measurement, and may configure the UE to perform the measurement separately for downlink and uplink, per DRB, and/or per UE. The measurements may be referred to as M6 measurements, in some examples. For sidelink M6 measurements, a UE may be configured (either by a base station or another UE) to measure a packet delay for sidelink. The M6 sidelink measurement may be per SL DRB and/or per UE. For the M6 sidelink measurements, the transmitting UE may compute the PDCP queuing delay (D1) at the transmitting UE and may indicate the D1 delay to the receiving UE over sidelink, such as in a PC5-RRC message. The receiving UE may measure an ADAPT layer delay, or a hop delay for relays, which is illustrated as D1.5. The receiving UE may compute the remaining portion (D2) of the SL packet delay e.g., HARQ retransmission delay, RLC delay.

In some aspects, a base station may configure a UE to perform measurement of a packet loss rate, and may configure the UE to perform the measurement separately for downlink and uplink, per DRB, and/or per UE. The measurements may be referred to as M7 measurements, in some examples. For sidelink M7 measurements, a UE may be configured (either by a base station or another UE) to measure a packet loss rate for sidelink. The M7 sidelink measurement may be per SL DRB and/or per UE. For the M7 sidelink measurements, a UE may compute a SL PDCP SDU loss rate and a SL RLC SDU loss rate.

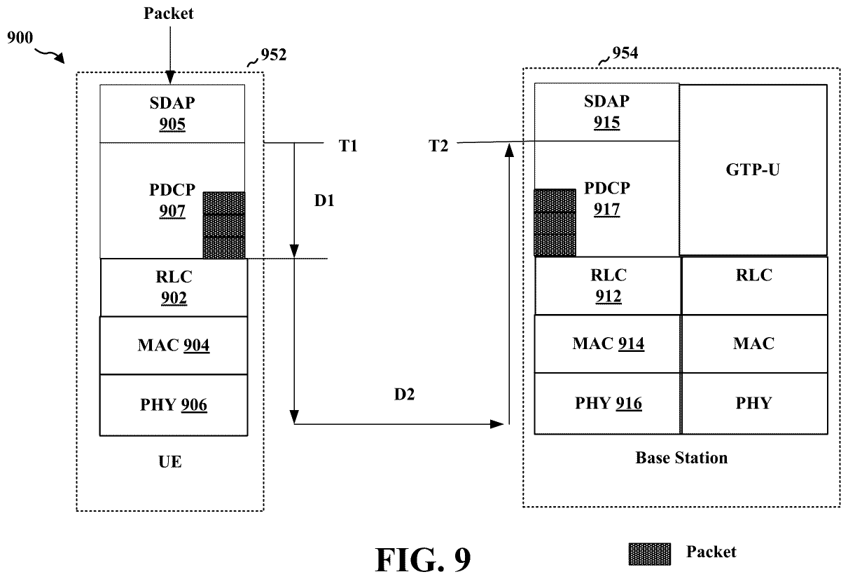

FIG. 9 illustrates an example protocol diagram 900 and delay measurements (e.g., D1 and D2) associated with an uplink transmission from a UE 952 to a base station 954. FIG. 9 illustrates an uplink PDCP queuing delay (D1) of packet, at the PDCP layer 907 of the UE 952 following the SDAP layer 905. D1 may correspond to the average PDCP queuing delay in the UE. D1 may be measured by the UE. The remaining uplink delay, e.g., due to the RLC layer 902, MAC layer 904, PHY layer 906 of the UE and the PHY layer 916, MAC layer 914, RLC layer 912, and PDCP layer 917 of the base station 954 corresponds to D2 (e.g., the RLC delay and over-the-air delay). The total delay (e.g., D1+D2) indicates the delay extending from the SDAP 905 protocol of the UE 952 (e.g., at time T1) to the SDAP 915 layer of the base station 954 (e.g., at timerT2).

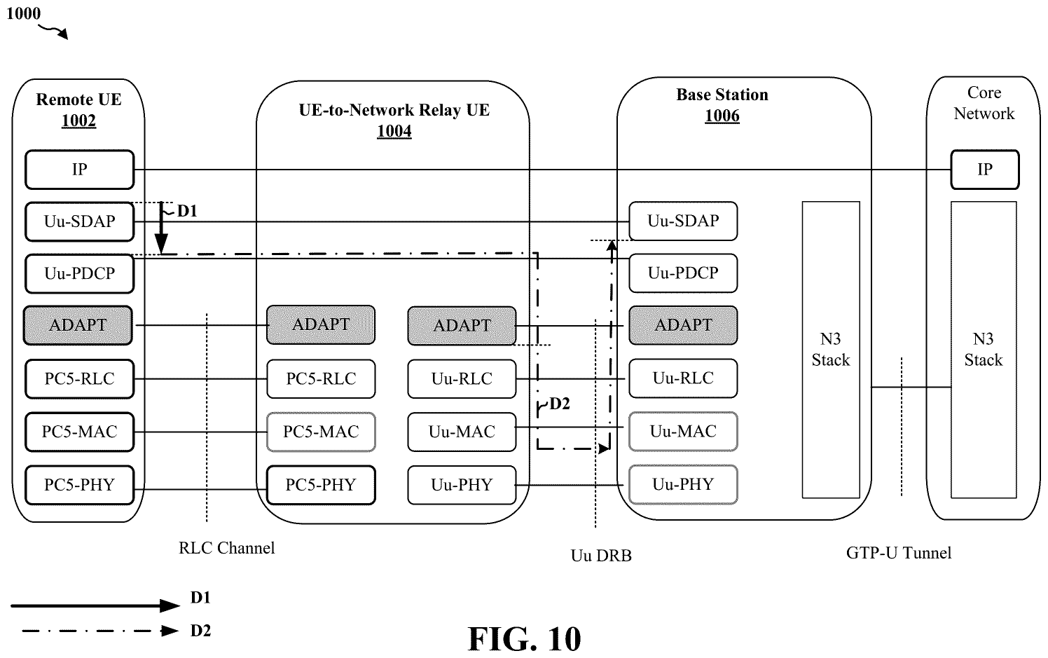

For L2 relays, the remote UE does not include a PC5 PDCP in the relay procedure, and the relay UE has an adaptation layer (e.g., ADAPT layer), and the measurement of the delay may be different than for uplink or downlink transmissions. The sidelink MDT measurements may include a measurement of an intermediate delay that captures queueing delay or hop delay while traversing through a relay UE. FIG. 10 illustrates a diagram 1000 showing example aspects of delay for L2 relay. The delay at the remote UE 1002 is indicated by D1, and corresponds to a delay at an SDAP layer of the remote UE. The intermediate delay may be measured by the relay UE 1004. The delay measurements may include a hop delay in the path between a remote UE 1002 and a relay UE 1004 (including in the ADAPT layer) and the queuing delay in sending packet from the ADAPT layer to the RLC layer in the relay UE 1004. The remaining delay measurement D2 (e.g., from the adapt layer at the relay UE 1004 through the PDCP layer of the base station 1006 may be used to capture the delay in the path between the relay UE 1004 and the base station 1006.

There may be an N: 1 bearer mapping between a sidelink RLC (e.g., PC5 RLC) and a Uu RLC. In order to measure a per-Uu DRB latency measurement, various options may be employed. In a first example, D2 may be measured by the relay UE 1004 per DRB, e.g., as an aggregated (e.g., combined) delay report of each of the PC5 RLC (of one or more remote UEs) mapped to a particular Uu RLC of the remote UE. In another example, the relay UE 1004 may measure D2 independently for each sidelink RLC (e.g., PC5 RLC). The relay UE 1004 may report the independent measurements with a DRB ID so that the measurements are capable of being accumulated based on the reported measurements. As an example, the measurements may be accumulated at a base station, a TCE, etc. In the example in FIG. 10, the total delay corresponds to D1+D2.

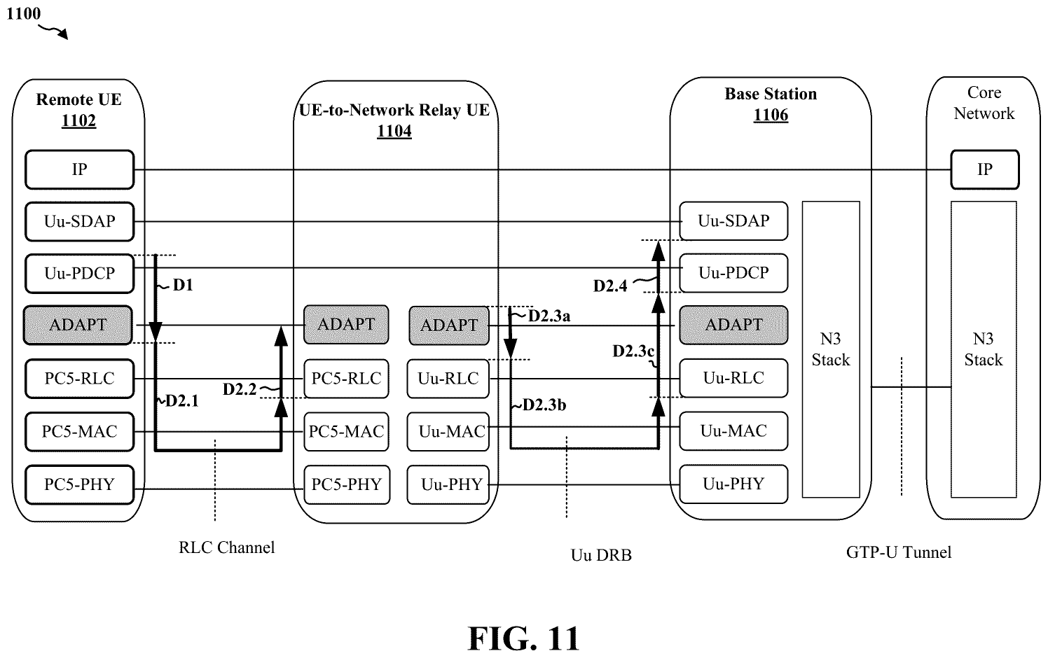

FIG. 11 illustrates additional aspects of delay(s) in a UE-to-network relay 1100 involving a remote UE 1102 and a relay UE 1104 that receives communication from the remote UE over sidelink and relays the communication to the base station 1106 over an access link (e.g., Uu link) with the base station 1106. Although FIG. 11 illustrates an example of a remote UE and a relay UE, the aspects performed by the relay UE and/or the remote UE may be performed IAB nodes or other wireless devices. DI may correspond to a PDCP queuing delay in the remote UE 1102, and may be measured by the remote UE 1102. D2.1 may correspond to a HARQ (re)transmission delay that is measured by the relay UE 1104. D2.2 may correspond to an RLC delay at the relay UE and may be measured by the relay UE. D2.4 may correspond to a PDCP reordering delay at the relay UE 1104, and may be measured by the relay UE 1104. D2.3 may correspond to an F1-U delay, which may be based on a combination of multiple separate delays (e.g., D2.3a, D2.3b, D2.3c, and D2.3d). As an example D2.3 may be represented by the formula D2.3=(D2.3a+D2.3b+D2.3c+D2.3d). In some aspects, a relay may correspond to an IAB node, e.g., which may relay communication from a UE to a network, between IAB nodes, etc. Although FIG. 10 illustrates an example of a remote UE and a relay UE, the aspects performed by the relay UE and/or the remote UE may be performed IAB nodes or other wireless devices. The delay D2.3a may correspond to an IAB-MT delay (e.g., a backhaul adaptation protocol (BAP) delay), and may be measured by the relay. Although aspects are described herein for remote and relay UEs, similar aspects may be applied for IAB nodes. The delay 2.3b may correspond to an air interface delay between the relay and the base station, and may be measured by the base station DU (e.g., a gNB-DU in some aspects). The delay 2.3c may correspond to an IAB-DU delay (e.g., an RLC delay and Rx BAP delay), and may be measured by the base station DU (e.g., a gNB-DU in some aspects). The delay D2.3d may correspond to a transport delay between a donor CU and a donor DU, and may be measured by a CU-UP. Table 1 and Table 2 illustrate various examples of delay that may be measured for an uplink delay in UE-to-network relays.

TABLE 1

| UL Delay Component | Measuring Entity |
|---|---|
| D1: PDCP queuing delay in the UE | Remote UE |
| D2.1: HARQ (re)transmission delay | Relay UE |
| D2.2: RLC delay | Relay UE |
| D2.3: F1-U delay | Entities in Table 2 |
| D2.4: PDCP reordering delay | CU-UP |

TABLE 2

| F1-U Delay on UL Component | Measuring Entity |
|---|---|
| D2.3a: IAB-MT delay (BAP delay) | Relay UE |
| D2.3b: Air interface delay | Base station-DU |
| D2.3c: IAB-DU delay (RLC delay and | Base station-DU |
| Rx BAP delay | |
| D2.3d: Transport Delay between Donor | CU-UP |
| CU and Donor DU | |

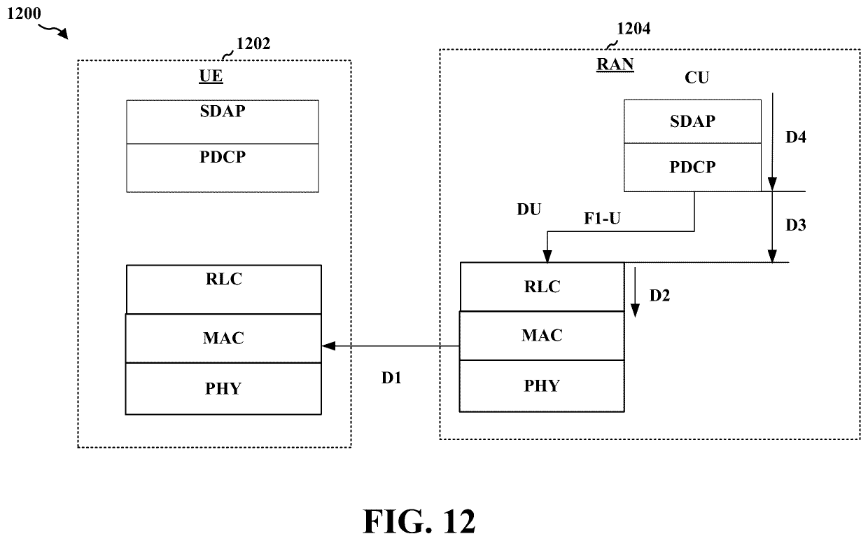

FIG. 12 illustrates an example of downlink delay components 1200 that may be measured between a UE 1202 and a base station 1204. The delay D1 in FIG. 12 may correspond to a downlink delay over the air interface, and may be measured by a DU. The delay D2 may correspond to an RLC SDU delay at the DU, and may be measured at the DU. The delay D3 may correspond to a downlink delay on the F1-U interface and may be measured by the CU-UP. The delay D4 may correspond to a PDCP SDU delay, and may be measured at the CU-UP. Table 3 illustrates various examples of delay that may be measured for the downlink delay.

TABLE 3

| DL Delay Component | Measuring Entity |
|---|---|
| D1: DL delay in over the air interface | Base station-DU |
| D2: RLC SDU delay | Base station-DU |
| D3: DL delay on F1-U | Base station-CU-UP |
| D4: PDCP SDU delay | Base station-CU-UP |

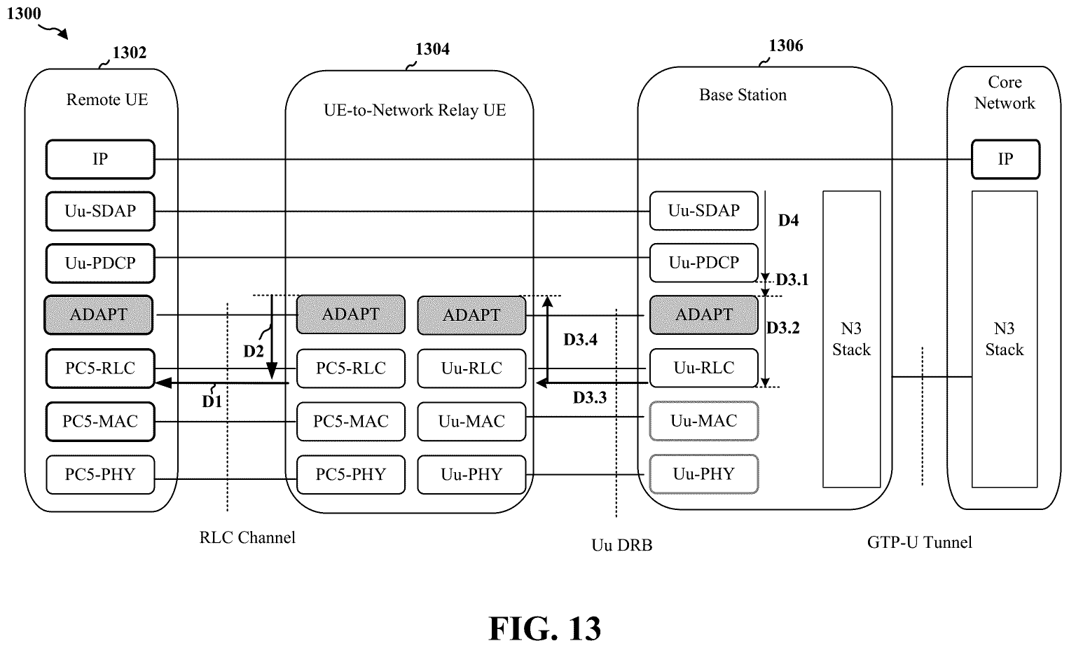

FIG. 13 illustrates a diagram 1300 showing components of downlink delay in a UE-to-network relay including a remote UE 1302, a relay UE 1304, and a base station 1306. Although FIG. 13 illustrates an example of a remote UE and a relay UE, the aspects performed by the relay UE and/or the remote UE may be performed IAB nodes or other wireless devices. The delay DI in FIG. 13 may correspond to a downlink delay in the over-the-air interface between the relay UE 1304 and the remote UE 1302, and may be measured by the remote UE. The delay D2 may correspond to the transmission delay for the relay UE, and may be measured at the relay UE 1304. The delay D3 may correspond to a delay between the base station 1306 and the relay UE 1304, and may be measured by the base station CU=UP. The delay D4 may correspond to a PDCP SDU delay at the base station, and may be measured by the base station CU-UP. Table 4 illustrates various examples of delay that may be measured as a part of the downlink delay, and the corresponding entity that may measure the delay.

TABLE 4

| DL Delay Component | Measuring Entity |
|---|---|
| D1: DL delay in over the air interface | Remote UE |
| D2: Transmission delay for relay UE | Relay UE |
| D3: Delay between the base station to | Base station-CU-UP |
| the relay UE | |
| D4: PDCP SDU delay | Base station-CU-UP |

The delay D3 may correspond to a combination of partial delays (e.g., D3.1, D3.2, D3.3, and D3.4). In some aspects, the delay D3 in FIG. 13 may be represented by the formula:

$$D 3 = D 3.1 + D 3.2 + D 3.3 + D 3.4$$

The delay D3.1 may correspond to a transport delay between the CU and adapt layer of the base station, and may be measured by the CU-UP. The delay D3.2 may correspond to an adapt layer delay (e.g., including both the time for processing at the adapt layer and the RLC delay), and may be measured by the DU. The delay 3.3 may correspond to a Uu air interface delay between the base station 1306 and the relay UE 1304, and may be measured by the DU. The delay 3.4 may correspond to the reception delay for the relay UE 1304 (e.g., including the processing time at the RLC and adapt layer in the relay UE 1304), and may be measured by the relay UE. Table 5 illustrates various examples of the F1-U delay that may be measured as a part of the downlink delay, and the corresponding entity that may measure the delay components.

TABLE 5

| F1-U Delay on DL Component | Measuring Entity |
|---|---|
| D3.1: Transport delay between the DU | Base station-CU-UP |
| and the adapt layer of the base station | |
| D3.2: Adapt layer delay (including | Base station DU |
| ADAPT and RLC delay in the base | |
| station) | |
| D3.3: Uu air interface delay | Base station DU |
| D3.4: Reception delay for the relay UE | Relay UE |
| (including RLC and adapt delay in | |
| relay UE) | |

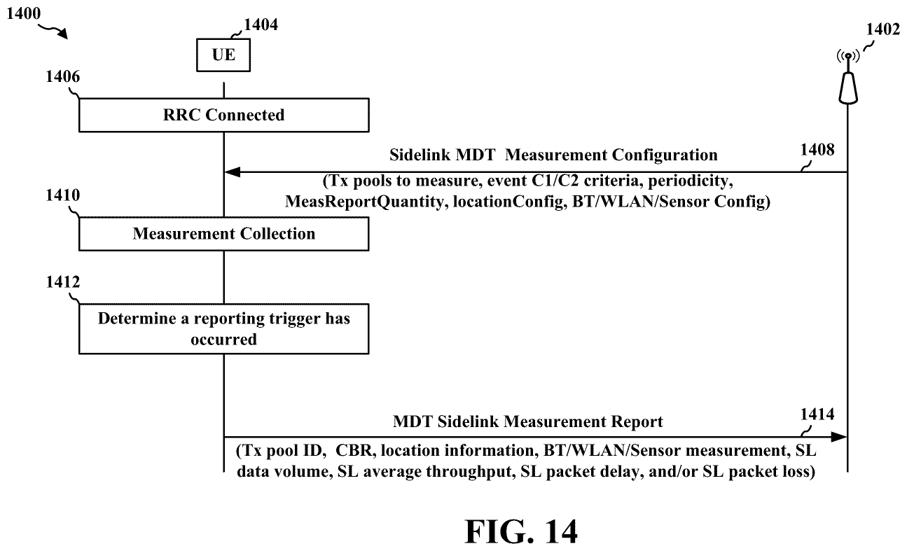

In some aspects, a base station may configure a UE to collected and provide sidelink related MDT measurements that are not logged or stored while the UE is in an RRC idle/inactive state. In some aspects, the measurements may be referred to as immediate MDT measurements in order to distinguish from a configuration for logged MDT measurements. FIG. 14 illustrates an example communication flow 1400 between a base station 1402 (e.g., RAN) and a UE 1404 including immediate sidelink MDT measurement reporting. The aspects presented in connection with FIG. 14 may enable the base station 1402 to collect sidelink related key performance indicators (KPIs) from the UE 1404. The UE 104 may be in an RRC connected state 1406 with the base station 1402. As illustrated at 1408, the base station 1402 may transmit an MDT measurement configuration to the UE 1404 to collect and/or report sidelink MDT measurements. The configuration may include a measurement configuration and/or a report configuration for the sidelink MDT measurements. The measurement configuration 1408 may indicate one or more sidelink transmission pools in which the UE 1404 is to perform the MDT measurements. The measurement configuration 1408 may indicate one or more events that trigger an MDT report from the UE 1404. The measurement configuration 1408 may indicate a periodicity for the MDT report. The measurement configuration 1408 may indicate a measurement report quantity, e.g., including a location configuration associated with for the MDT measurements, or a configuration to report measurements of other RATs, such as bluetooth, WLAN, sensor measurements, with the sidelink MDT measurements. For example, in addition to sidelink measurements such as a CBR, the base station 1402 may configure the UE 1404 in RRC_CONNECTED state to report the sidelink data volume, sidelink average throughput, sidelink packet delay, sidelink packet loss, or SD-RSRP measurements along with detailed location information for the measurements and/or BT/WLAN/sensor measurements for certain Tx resource pools.

In response to the configuration, the UE 1404 may perform the configured measurements. At 1412, the UE may determine that a reporting trigger has occurred. In some aspects, the base station 1402 may configure the UE 1404 to provide periodic reports, and the trigger event that is detected at 1412 may be the expiration of a timer associated with the period, or an amount of time associated with the period having passed. In some aspects, the base station 1402 may configure the UE 1404 with one or more event criteria to trigger an MDT report of the sidelink measurements. The trigger at 1412, may be the occurrence of an event that meets the event criteria of the configuration received from the base station 1402 at 1408.

In response to the detection of the occurrence of the reporting trigger, at 1412, the UE 1404 transmits the measurement report of the measurements collected at 1410. The measurement report may indicate a corresponding transmission pool ID for the measurements, a CBR or other sidelink measurement, location information associated with the measurement (e.g., a location of the UE 1404 at the time of measurement), bluetooth/WLAN/sensor measurements, a sidelink data volume, a sidelink average throughput, a sidelink packet delay, a sidelink packet loss, etc.

In some aspects, the UE 1404 may skip reporting the detailed location information and BT/WLAN/sensor measurements along with sidelink measurement results, at 1414, e.g., if the location/other measurements will be, have been, or are being reported with intra-RAT and/or inter-RAT Uu measurements for MDT purposes.

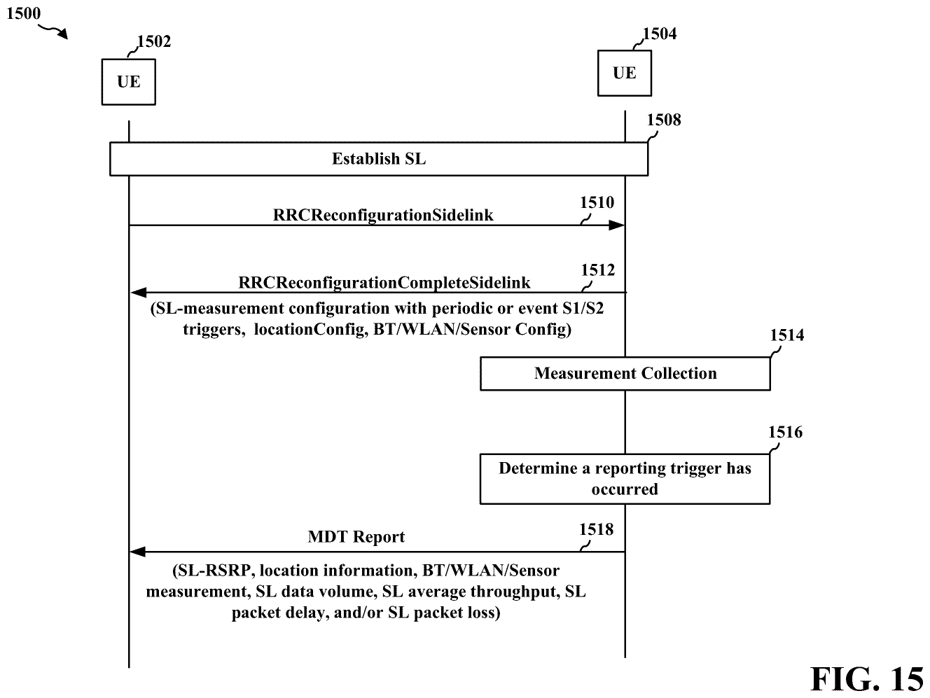

In some aspects, a first UE may configure a second UE to provide sidelink MDT measurements. FIG. 15 illustrates an example communication flow 1500 between a first UE 1502 and a second UE 1504 including (e.g., immediate) sidelink MDT measurement reporting. The aspects presented in connection with FIG. 15 may enable the first UE to collect sidelink related KPIs from the second UE 1504. The UEs 1502 and 1504 may have a link established for sidelink communication (e.g., a PC5 link), at 1508.

As illustrated at 1510, the first UE 1502 may transmit an MDT measurement configuration to the second UE 1504 to collect and/or report sidelink MDT measurements. In some aspects, the configuration 1510 may be provided in a sidelink RRC message, such as an RRC reconfiguration message for sidelink (e.g., which may be referred to as an RRCReconfigurationSidelink message). The configuration 1510 may include a measurement configuration and/or a report configuration for the sidelink MDT measurements. As an example, in addition to SL-RSRP measurement, the first UE 1502 may configure the second UE 1504, e.g., as a peer UE connected via a unicast sidelink such as a PC5 unicast link, to report sidelink data volume, sidelink average throughput, sidelink packet delay, sidelink packet loss, etc. The configuration may indicate one or more sidelink resource pools for which the UE is to perform the configured measurements. The measurement configuration 1510 may include any of the aspects described in connection with FIG. 14. The measurement configuration 1510 may indicate one or more events (e.g., S1/S2) that trigger an MDT report from the second UE 1504. The measurement configuration 1510 may indicate a periodicity for the MDT report. The measurement configuration 1510 may indicate a location configuration associated with for the MDT measurements, or a configuration to report measurements of other RATs, such as bluetooth, WLAN, sensor measurements, with the sidelink MDT measurements. For example, in addition to sidelink measurements such as a CBR, the first UE 1502 may configure the second UE 1504 to report the sidelink data volume, sidelink average throughput, sidelink packet delay, sidelink packet loss, or SD-RSRP measurements along with detailed location information for the measurements and/or BT/WLAN/sensor measurements for certain Tx resource pools.

In response to receipt of the configuration 1510, the second UE 1504 may transmit a reply message, such as an RRC reconfiguration complete sidelink message 1512.

The UE 1504 may perform the configured measurements, at 1514. At 1516, the second UE 1504 may determine that a reporting trigger has occurred. In some aspects, the first UE 1502 may configure the second UE 1504 to provide periodic reports, and the trigger event that is detected at 1516 may be the expiration of a timer associated with the period, or an amount of time associated with the period having passed. In some aspects, the first UE 1502 may configure the second UE 1504 with one or more event criteria to trigger an MDT report of the sidelink measurements. The trigger at 1516, may be the occurrence of an event that meets the event criteria of the configuration received from the first UE 1502 at 1510.

In response to the detection of the occurrence of the reporting trigger, at 1510, the second UE 1504 transmits the measurement report of the measurements collected at 1518. The measurement report may indicate a SL-RSRP or other sidelink measurement, location information associated with the measurement (e.g., a location of the second UE 1504 at the time of measurement), bluetooth/WLAN/sensor measurements, a sidelink data volume, a sidelink average throughput, a sidelink packet delay, a sidelink packet loss, etc. The report may include aspects of the report described in connection with FIG. 14.

In some aspects, the second UE 1504 may skip reporting the detailed location information and BT/WLAN/sensor measurements along with sidelink measurement results, at 1518, e.g., if the location/other measurements will be, have been, or are being reported with intra-RAT and/or inter-RAT Uu measurements for MDT purposes.

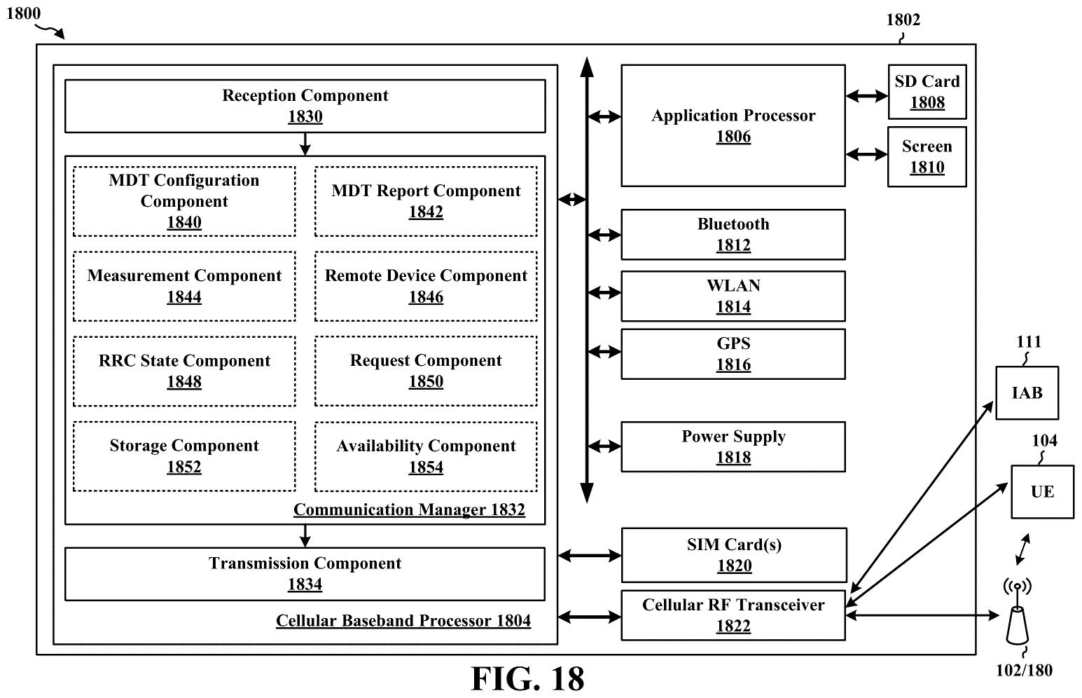

FIG. 16A is a flowchart 1600 of a method of wireless communication. The method may be performed by a relay device, such as the apparatus 1802 in FIG. 18; the device 310 or 350. In some aspects, the method may be performed by a UE operating as a relay UE in a UE-to-network relay. In some aspects, the method may be performed by another device, such as an IAB node (e.g., IAB node 111). For example, the method may be performed by a UE or a component of a UE (e.g., the UE 104, 702, 1502; the relay UE 504, 604, 804, 1004, 1104, 1304, 1404). The method may enable a UE, or other device, to collect and provide MDT measurements for sidelink.

At 1602, the relay device receives, from the base station, a configuration for MDT measurements associated with sidelink communication. FIGS. 6, 8, and 14 illustrate various examples of a UE (e.g., as one non-limiting example of a relay device) receiving a configuration for MDT measurements associated with sidelink. The configuration may include any of the aspects described in connection with 616, 808A, and/or 1408. The reception of the configuration may be performed, e.g., by the MDT configuration component 1840 of the apparatus 1802 in FIG. 18. The configuration indicates one or more of: at least one sidelink transmission resource pool for the relay device to collect the MDT measurements when in the RRC idle or the RRC inactive state, sidelink frequency information, a CBR measurement configuration, or an event trigger for collecting logged MDT measurements. In some aspects, the MDT measurements configured by the base station may include one or more of: sidelink signal quantity measurement, a packet data convergence protocol (PDCP) service data unit (SDU) data volume measurement for sidelink, an average UE throughput measurement for the sidelink, a packet delay measurement for the sidelink, or a packet loss rate measurement for the sidelink. The report may indicate the MDT measurements per Sidelink data radio bearer (SL-DRB) and per UE (e.g., per remote device). In some aspects, the MDT measurements include a delay between the remote device and the relay device, which can include queuing delay in PDCP layer of remote UE, air-interface delay between remote device and relay device and queuing delay in Adaptation layer (ADAPT) of the remote device and/or relay device.

At 1614, the relay device transmits a report of the MDT measurements to the base station based on the configuration. FIGS. 6, 8, and 14 illustrate example aspects of a relay device providing the MDT measurements in a report to the base station. The transmission of the report may be performed, e.g., by the MDT report component 1842 of the apparatus 1802 in FIG. 18.

FIG. 16B illustrates a communication flow 1650 that may include the aspects of the flowchart 1600 in FIG. 16A.

In some aspects, the configuration that is received at 1602 may be for a logged MDT procedure at a relay device when the relay device is in an RRC idle state or an RRC inactive state. FIG. 6 illustrates example aspects of a logged MDT procedure configuration. As illustrated at 1608, the relay device may transition from an RRC connected state to the RRC idle state or the RRC inactive state. The transition may be performed, e.g., by the RRC state component 1848 of the apparatus 1802 in FIG. 18. FIG. 6 illustrates an example of a relay device transitioning from the RRC connected state to the RRC idle/inactive state and collecting logged MDT measurements for sidelink in the RRC idle/inactive state.

As illustrated at 1610, the relay device may store the MDT measurements associated with the sidelink communication. The storage may be performed, e.g., by the storage component 1852 of the apparatus 1802 in FIG. 18. As an example, in FIG. 6, the UE 604 may store the collected MDT measurements based on the logged measurement configuration.

As illustrated at 1612, the relay device may transition to the RRC connected state prior to transmitting the report of the MDT measurements. The transition may be performed, e.g., by the RRC state component 1848 of the apparatus 1802 in FIG. 18. FIG. 6 illustrates an example of the UE 604 transitioning to the RRC connected state and transmitting a logged MDT measurement report.

In some aspects, the relay device may be a relay UE, and the configuration may be for a logged MDT procedure at the remote device when the remote device is in a RRC idle state or an RRC inactive state. FIG. 8A illustrates and example of a relay device receiving a logged MDT configuration from a base station and providing the configuration over sidelink to a remote device. The relay device may receive the MDT measurements from the remote device, at 1606. The receipt may be performed, e.g., by the remote device component 1846 of the apparatus 1802 in FIG. 18. The relay device may transmit the MDT measurements from the remote device in the report to the base station, at 1614. The transmission may be performed, e.g., by the MDT report component 1842. For example, FIG. 8A and 8B illustrate examples of the relay UE 804 receiving the logged MDT reports 816B, 816C, and/or 816D from the remote UE(s) and providing the logged MDT report to the base station. In some aspects, the relay device may transmit the MDT measurements from the remote device to the base station without storage, e.g., as shown by the arrow directly between 1606 and 1614. In some aspects the relay device may transmit the MDT measurements from the remote device in a transparent container from the relay device to the base station. In some aspects, the relay device may store the MDT measurements, at 1610, from the remote device before sending the MDT report to the base station, at 1614. As an example, the relay device may receive the MDT measurements from multiple remote devices and may store the MDT measurements, at 1610, from the multiple remote devices while in the RRC idle state or the RRC inactive state. The relay device may transition to an RRC connected state, at 1612, prior to transmitting the report, at 1614, the report including aggregate MDT measurements for the multiple remote devices. FIG. 8B illustrates an example of a relay device storing MDT report from one or more UEs before transmitting the MDT reports to the base station.

In some aspects, the MDT measurements configured by the base station include a measurement of a delay between the remote device and the relay device, the delay including at least one of a queuing delay in a packet data convergence protocol (PDCP) layer of the remote UE, an air-interface delay between the remote device and the relay device and a queuing delay in an Adaptation layer (ADAPT) of the remote device or the relay device. FIGS. 9-12 illustrate various aspects of delay that may be configured for measurement. As illustrated at 1604, the relay device may measure the delay between the remote device and the relay device per data radio bearer (DRB) for one or more remote devices, wherein the report to the base station includes an indication of the delay. At 1604, the relay device may measure the delay between the remote device and the relay device per sidelink RLC for one or more remote devices, wherein the report to the base station includes an indication of the delay per the sidelink RLC and a corresponding DRB ID. The measurement(s) may be performed, e.g., by the measurement component 1844 of the apparatus 1802 in FIG. 18.

In some aspects, the configuration may indicate for the relay device or the remote device (or a UE) to report the MDT measurements for one or more sidelink transmission resource pools, the MDT measurements including at least one of a sidelink data volume, a sidelink average throughput, a sidelink packet delay, a sidelink packet loss, a sidelink discovery reference signal received power (SD-RSRP), and the configuration indicates for the MDT measurements to be associated with one or more of location information, an additional measurement of a different RAT than sidelink (e.g., bluetooth or WLAN among other examples), or one or more sensor measurements. FIG. 14 illustrates example aspects of a sidelink MDT measurement configuration 1408. The report of the MDT measurements, at 1614, may be periodic or based on an occurrence of a trigger event. FIG. 14 illustrates example aspects that may trigger an MDT report. In some aspects, the relay device may skip transmission of the location information or the additional measurement of the different RAT in the report based on the location information or the measurements of the different RAT being reported with inter-RAT or intra-RAT MDT measurements for Uu.

FIG. 17 is a flowchart 1700 of a method of wireless communication. The method may be performed by a wireless device (e.g., the device 310 or 350; the apparatus 1802). In some aspects, the method may be performed by a UE operating as a relay UE in a UE-to-network relay. For example, the method may be performed by a UE or a component of a UE (e.g., the UE 104, 702, 1502; the relay UE 504, 604, 804, 1004, 1104, 1304, 1404). In some aspects, the method may be performed by another device, such as an IAB node (e.g., IAB node 111). The method may enable the UE to configure a peer UE to provide MDT measurements for sidelink.

At 1702, the first UE transmits to a second UE, a configuration for logged MDT measurements associated with sidelink communication. The transmission may be performed, e.g., by the remote device component 1846 and/or the MDT configuration component 1840 of the apparatus 1802 in FIG. 18. The configuration may include any of the aspects described in connection with 616, 808A, and/or 1408. The reception of the configuration may be performed, e.g., by the MDT configuration component 1840 of the apparatus 1802 in FIG. 18. The configuration indicates one or more of: at least one sidelink transmission resource pool for the relay UE to collect the MDT measurements when in the RRC idle or the RRC inactive state, sidelink frequency information, a CBR measurement configuration, or an event trigger for collecting logged MDT measurements. In some aspects, the MDT measurements configured by the base station may include one or more of: sidelink signal quantity measurement, a PDCP SDU data volume measurement for sidelink, an average UE throughput measurement for the sidelink, a packet delay measurement for the sidelink, or a packet loss rate measurement for the sidelink. The report may indicate the MDT measurements per SL-DRB and per UE.

The configuration may be for a logged MDT procedure at the remote UE when the remote UE is in a RRC idle state or an RRC inactive state. FIG. 8A illustrates and example of a relay UE receiving a logged MDT configuration from a base station and providing the configuration over sidelink to a remote UE.

In some aspects, the MDT measurements may include a measurement of a delay between the remote UE and the relay UE. In some aspects, the configuration may be to measure a queuing delay in the Adaptation layer or PDCP layer of the remote UE or relay UE. In some aspects, the configuration may indicate for the second UE to report the MDT measurements for one or more sidelink transmission resource pools, the MDT measurements including at least one of a sidelink data volume, a sidelink average throughput, a sidelink packet delay, a sidelink packet loss, a SD-RSRP, and the configuration indicates for the MDT measurements to be associated with one or more of location information, an additional measurement of a different RAT than sidelink (e.g., bluetooth or WLAN among other examples), or one or more sensor measurements. FIG. 15 illustrates example aspects of a sidelink MDT measurement configuration 1408. The report of the MDT measurements, at 1708, may be periodic or based on an occurrence of a trigger event. FIG. 15 illustrates example aspects that may trigger an MDT report. In some aspects, the UE may skip transmission of the location information or the additional measurement of the different RAT in the report based on the location information or the measurements of the different RAT being reported with inter-RAT or intra-RAT MDT measurements for Uu.

At 1704, the first UE receives an availability indication of logged MDT measurements from the second UE. The reception may be performed, e.g., by the availability component 1854 of the apparatus 1802 in FIG. 18. At 1706, the first UE transmits a request for the logged MDT measurements to the second UE. The transmission may be performed, e.g., by the request component 1850 and/or the remote device component 1846 of the apparatus 1802 in FIG. 18. FIG. 8A illustrates an example of a base station receiving the availability indication and sending the request.

At 1708, the first UE receives the logged MDT measurements from the second UE over sidelink. The report may be received, e.g., by the MDT report component 1842 and/or the remote device component 1846 of the apparatus 1802 in FIG. 18. The relay UE may then transmit the MDT measurements from the remote UE in a report to the base station. For example, FIG. 8A and 8B illustrate examples of the relay UE 804 receiving the logged MDT reports 816B, 816C, and/or 816D from the remote UE(s) and providing the logged MDT report to the base station. In some aspects, the relay UE may transmit the MDT measurements from the remote UE to the base station without storage. In some aspects the relay UE may transmit the MDT measurements from the remote UE in a transparent container from the relay UE to the base station. In some aspects, the relay UE may store the MDT measurements from the remote UE before sending the MDT report to the base station, at 1614. As an example, the relay UE may receive the MDT measurements from multiple remote UEs.

FIG. 18 is a diagram 1800 illustrating an example of a hardware implementation for an apparatus 1802. In some aspects, the apparatus 1802 may be a UE, a component of a UE, or may implement UE functionality. In some aspects, the apparatus 1802 may be an IAB node, a component of an IAB node, or may implement IAB node functionality. In some aspects, the apparatus 1802 may include a baseband processor 1804 (also referred to as a modem) coupled to an RF transceiver 1822. In some aspects, the baseband processor may be a cellular baseband processor and the RF transceiver may be a cellular RF transceiver. In some aspects, the apparatus 1802 may further include one or more subscriber identity modules (SIM) cards 1820, an application processor 1806 coupled to a secure digital (SD) card 1808 and a screen 1810, a Bluetooth module 1812, a wireless local area network (WLAN) module 1814, a Global Positioning System (GPS) module 1816, or a power supply 1818. The baseband processor 1804 communicates through the RF transceiver 1822 with the UE 104 base station 102/180, and/or IAB node 111. The baseband processor 1804 may include a computer-readable medium/memory. The computer-readable medium/memory may be non-transitory. The baseband processor 1804 is responsible for general processing, including the execution of software stored on the computer-readable medium/memory. The software, when executed by the baseband processor 1804, causes the baseband processor 1804 to perform the various functions described supra. The computer-readable medium/memory may also be used for storing data that is manipulated by the baseband processor 1804 when executing software. The baseband processor 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the baseband processor 1804. The baseband processor 1804 may be a component of the device 350 and may include the memory 360 and/or at least one of the TX processor 368, the RX processor 356, and the controller/processor 359. In one configuration, the apparatus 1802 may be a modem chip and include just the baseband processor 1804, and in another configuration, the apparatus 1802 may be the entire UE (e.g., see the device 350 of FIG. 3) and include the additional modules of the apparatus 1802.

The communication manager 1832 includes an MDT configuration component 1840 that is configured to receive a configuration for MDT measurements associated with sidelink communication, e.g., as described in connection with 1602 in FIG. 16A or 16B. The MDT configuration component 1840 may be further configured to transmit, to a second UE (or IAB node), a configuration for logged MDT measurements associated with sidelink communication, e.g., as described in connection with 1702 in FIG. 17. The communication manager 1832 further includes an MDT report component 1842 that is configured to transmit a report of the MDT measurements to the base station based on the configuration, e.g., as described in connection with 1614 in FIG. 16A or 16B. In some aspects, the MDT report component 1842 may be configured to receive logged MDT measurements from the second UE (or IAB node) over sidelink, e.g., as described in connection with FIG. 17. The communication manager 1832 further includes a measurement component 1844 that is configured to measure delay between the remote device and the relay device, e.g., as described in connection with 1604 in FIG. 16B. The communication manager 1832 further includes a remote device component 1846 that is configured to receive the MDT measurements from the remote device, e.g., as described in connection with 1606 in FIG. 16B. The communication manager 1832 further includes an RRC state component 1848 that is configured to transition between an RRC connected state and an RRC idle or inactive state, e.g., as described in connection with 1608 and/or 1612 in FIG. 16B. The communication manager 1832 further includes a request component 1850 that is configured to transmit a request for a logged MDT measurement to the second UE (or IAB node), e.g., as described in connection with 1706 in FIG. 17. The communication manager 1832 further includes a storage component 1852 that is configured to the MDT measurements associated with the sidelink communication, e.g., as described in connection with 1610 in FIG. 16B. The communication manager 1832 further includes an availability component 1854 that is configured to receive an availability indication of logged MDT measurements from the second UE or IAB node), e.g., as described in connection with 1704 in FIG. 17.

The apparatus may include additional components that perform each of the blocks of the algorithm in the flowcharts of FIGS. 16A, 16B, or 17, and/or the aspects performed by the relay UE in the communication flows in FIGS. 6, 8A, 8B, or 14. As such, each block in the flowcharts of FIGS. 16A, 16B, or 17, and/or the aspects performed by the relay UE in the communication flows in FIGS. 6, 8A, 8B, or 14 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1802 may include a variety of components configured for various functions. In one configuration, the apparatus 1802, and in particular the baseband processor 1804, includes means for receiving, from the base station, a configuration for MDT measurements associated with sidelink communication and means for transmitting a report of the MDT measurements to the base station based on the configuration. The apparatus 1802 may further include means for transitioning from an RRC connected state to the RRC idle state or the RRC inactive state, means for storing the MDT measurements associated with the sidelink communication, and means for transitioning to the RRC connected state prior to transmitting the report of the MDT measurements. The apparatus 1802 may further include means for receiving the MDT measurements from the remote device; and means for transmitting the MDT measurements from the remote device in the report to the base station. The apparatus 1802 may further include means for storing the MDT measurements from the multiple remote devices while in the RRC idle state or the RRC inactive state; and means for transitioning to an RRC connected state prior to transmitting the report, wherein the report comprises aggregate MDT measurements for the multiple remote devices. The apparatus 1802 may further include means for measuring the delay between the remote device and the relay device per DRB for one or more remote devices, wherein the report to the base station includes an indication of the delay. The apparatus 1802 may further include means for measuring the delay between the remote device and the relay device per sidelink RLC for one or more remote devices, wherein the report to the base station includes an indication of the delay per the sidelink RLC and a corresponding DRB ID. The apparatus 1802 may further include means for skipping transmission of the location information or the additional measurement of the different RAT in the report based on the location information or the measurements of the different RAT being reported with inter-RAT or intra-RAT MDT measurements for Uu. The means may be one or more of the components of the apparatus 1802 configured to perform the functions recited by the means. As described supra, the apparatus 1802 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 19A is a flowchart 1900 of a method of wireless communication. The method may be performed by a wireless device (e.g., the device 310 or 350; the apparatus 2002). The wireless device may be referred to as a remote device in order to distinguish from a second device that may be referred to as a relay device. The remote device and/or the relay device may be a UE, and IAB node, etc. In some aspects, the method may be performed by a UE operating as a remote UE in a UE-to-network relay. For example, the method may be performed by a UE or a component of a UE (e.g., the UE 104, 704, 1504; the remote UE 502, 602, 802, 1002, 1102, 1302, 1404). In some aspects, the method may be performed by another device, such as an IAB node (e.g., IAB node 111). The method may enable a device to collect and provide MDT measurements for sidelink.

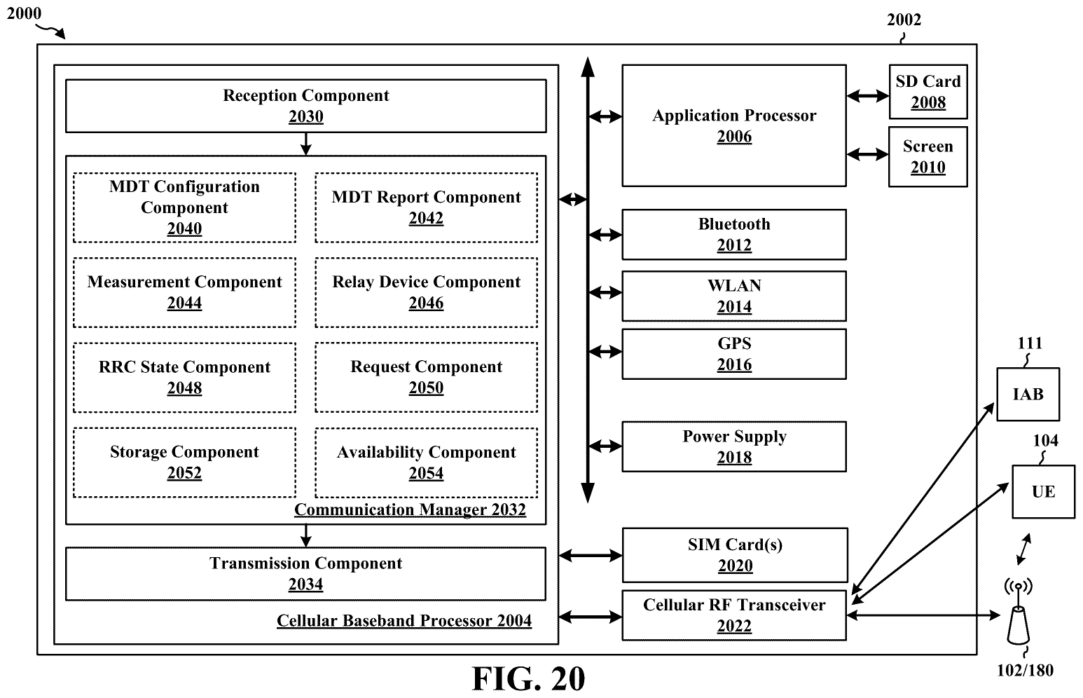

At 1902, the remote device receives, in a sidelink message from a relay device, a configuration for MDT measurements of sidelink communication. The reception may be performed, e.g., by the MDT configuration component 2040 of the apparatus 2002 in FIG. 20. In configuration may indicate one or more of: at least one sidelink transmission resource pool for the remote device to collect the MDT measurements when in an RRC idle state or an RRC inactive state, sidelink frequency information, a CBR measurement configuration, or an event trigger for collecting logged MDT measurements. The MDT measurements may include one or more of sidelink signal quantity measurement, a PDCP SDU data volume measurement for sidelink, an average device throughput measurement for the sidelink, a packet delay measurement for the sidelink, or a packet loss rate measurement for the sidelink. The MDT measurements may be configured to be measured per SL-DRB. The configuration may indicate for the remote device to report the MDT measurements for one or more sidelink transmission resource pools, the MDT measurements including at least one of a sidelink data volume, a sidelink average throughput, a sidelink packet delay, a sidelink packet loss, a SD-RSRP, and the configuration indicates for the measurements to be associated with one or more of location information, an additional measurement of a different RAT than sidelink, or one or more sensor measurements. The configuration may include any of the aspects described in connection with FIGS. 6-15. A device communicating with the base station via a relay device is illustrated in FIG. 1, 5, 6, 8A, 8B, 10, 11, and 13 illustrate example aspects of a remote device and a relay device.

At 1908, the remote device transmits the MDT measurements to the relay device. The transmission may be performed, e.g., by the MDT report component 2042 of the apparatus 2002 in FIG. 20. FIGS. 7, 8A, 8B, and 15 illustrate various examples of a device transmitting an MDT report to a second device.

FIG. 19B illustrates a method of wireless communication 1950 that may include 1902 and/or 1908 of FIG. 19A. At 1904, the remote device may transmit an availability indication of logged MDT measurements to the relay device. The transmission may be performed, e.g., by the availability component 2054 of the apparatus 2002 in FIG. 20. At 1906, the device receives a request for the logged MDT measurements from the relay device or the base station. The reception may be performed, e.g., by the request component 2050 of the apparatus 2002 in FIG. 20. FIG. 8A illustrates an example of a base station receiving the availability indication and sending the request. The remote device may transmit the logged MDT measurements to the relay device or the base station via the relay device.

In FIG. 20 is a diagram 2000 illustrating an example of a hardware implementation for an apparatus 2002. In some aspects, the apparatus 2002 may be a UE, a component of a UE, may implement UE functionality, or may be another device configured to transmit and/or receive sidelink communication. In some aspects the apparatus 2002 may be an IAB node, a component of an IAB node, or may implement IAB node functionality. The apparatus 2002 includes a baseband processor 2004 (also referred to as a modem) coupled to a RF transceiver 2022. In some aspects, the baseband processor 2004 may be a baseband processor and/or the RF transceiver 2022 may be a RF transceiver. The apparatus 2002 may further include one or more subscriber identity modules (SIM) cards 2020, an application processor 2006 coupled to a secure digital (SD) card 2008 and a screen 2010, a Bluetooth module 2012, a wireless local area network (WLAN) module 2014, a Global Positioning System (GPS) module 2016, and/or a power supply 2018. The baseband processor 2004 communicates through the RF transceiver 2022 with the UE 104, base station 102/180, and/or IAB node 111. The baseband processor 2004 may include a computer-readable medium/memory. The computer-readable medium/memory may be non-transitory. The baseband processor 2004 is responsible for general processing, including the execution of software stored on the computer-readable medium/memory. The software, when executed by the baseband processor 2004, causes the baseband processor 2004 to perform the various functions described in the present application. The computer-readable medium/memory may also be used for storing data that is manipulated by the baseband processor 2004 when executing software. The baseband processor 2004 further includes a reception component 2030, a communication manager 2032, and a transmission component 2034. The communication manager 2032 includes the one or more illustrated components. The components within the communication manager 2032 may be stored in the computer-readable medium/memory and/or configured as hardware within the baseband processor 2004. The baseband processor 2004 may be a component of the device 350 and may include the memory 360 and/or at least one of the TX processor 368, the RX processor 356, and the controller/processor 359. In one configuration, the apparatus 2002 may be a modem chip and include just the baseband processor 2004, and in another configuration, the apparatus 2002 may be the entire UE or IAB node (e.g., see 350 of FIG. 3) and include the additional modules of the apparatus 2002.

The communication manager 2032 includes an MDT configuration component 2040 that is configured to receive, in a sidelink message from a relay device, a configuration for logged MDT measurements associated with sidelink communication, e.g., as described in connection with 1902 in FIG. 19A or 19B. The communication manager 2032 further includes an MDT report component 2042 that is configured to transmit the MDT measurements to the relay device, e.g., as described in connection with 1908 in FIG. 19A or 19B. The communication manager 2032 may further include a measurement component 2044 that is configured to perform an MDT measurement based on the configuration. The communication manager 2032 may further include a relay device component 2046 that is configured to communicate with a base station via a relay device. The communication manager 2032 further includes an RRC state component 2048 that is configured to transition between an RRC connected state and an RRC inactive/idle state (e.g., with a base station). The communication manager 2032 may further include a request component 2050 that is configured to receive a request for the logged MDT measurements, e.g., as described in connection with 1906 in FIG. 19B. The communication manager 2032 may further include a storage component 2052 that is configured to store logged MDT measurements. The communication manager 2032 may further include an availability component 2054 that is configured to transmit an availability indication of logged MDT measurements to the relay device, e.g., as described in connection with 1904 in FIG. 19B.

The apparatus may include additional components that perform each of the blocks of the algorithm in the flowcharts of FIGS. 19A or 19B, and/or the aspects performed by the UE (e.g., as an example device) in any of FIGS. 5-15. As such, each block in the flowcharts of FIGS. 19A or 19B, and/or the aspects performed by the UE in any of FIGS. 5-15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 2002, and in particular the baseband processor 2004, includes means for receiving, in a sidelink message from a relay UE, a configuration for MDT measurements of sidelink communication, and means for transmitting the MDT measurements to the relay UE. The apparatus 2002 may further include means for transmitting an availability indication of the logged MDT measurements to the relay UE; means for receiving a request for the logged MDT measurements from the relay UE or from a base station via the relay UE; and means for transmitting the logged MDT measurements to the relay UE or to the base station via the relay UE. The means may be one or more of the components of the apparatus 2002 configured to perform the functions recited by the means. As described herein, the apparatus 2002 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 21A illustrates a flowchart for an example method 2100 of wireless communication. The method may be performed by a base station (e.g., the base station 102/180, 806, 954, 1006, 1106, 1204, 1306, 1402; the RAN 506, 606; the device 310; the apparatus 2202). The method may enable the base station to configure and collect MDT measurements for sidelink from one or more devices, or other devices. In some aspects, the devices may be a relay UE and/or a remote UE. In some aspects the devices may be a relay IAB node and/or a remote IAB node.

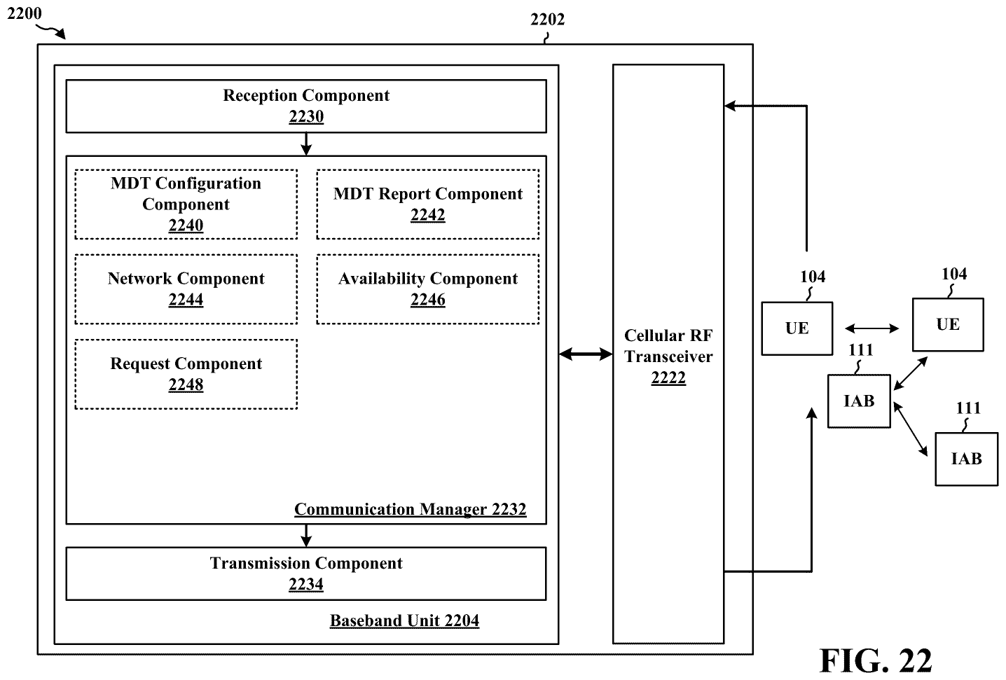

At 2104, the base station transmits a configuration for MDT measurements of sidelink communication for at least one of a relay device or a remote device served by the relay device. The transmission may be performed, e.g., by the MDT configuration component 2240 of the apparatus 2202 in FIG. 22. The configuration may be for a logged MDT procedure at the relay device when the relay device is in a RRC idle state or an RRC inactive state. The configuration may indicate one or more of at least one sidelink transmission resource pool for the relay device to collect the MDT measurements when in the RRC idle or the RRC inactive state, sidelink frequency information, a CBR measurement configuration, an event trigger for collecting logged MDT measurements, sidelink signal quantity measurement, a PDCP SDU data volume measurement for sidelink, an average device throughput measurement for the sidelink, a packet delay measurement for the sidelink, a packet loss rate measurement for the sidelink, a measurement of a delay between the remote device and the relay device, a queuing delay in an adaptation layer or a PDCP layer of the remote device or the relay device, a sidelink data volume, a sidelink average throughput, a sidelink packet delay, a sidelink packet loss, or a SD-RSRP. The configuration may include any of the aspects described in connection with FIGS. 6, 8A, 8B, or 14.

At 2108, the base station receives the MDT measurements from the at least one of the relay device or the remote device based on the configuration. The reception may be performed, e.g., by the MDT report component 2242 of the apparatus 2202 in FIG. 22. FIGS. 6, 8A, 8B, and 14 illustrate examples of a base station receiving MDT measurements for sidelink from a device. The MDT measurements from the relay device may include aggregate measurements and are received in response to an RRC connection with the relay device. FIG. 8B illustrates an example with aggregate measurements. The configuration is for a logged MDT procedure at the remote device when the remote device is in an RRC idle state or an RRC inactive state, and the MDT measurements may be from the remote device via the relay device. The MDT measurements from the remote device, at 2108, may be comprised in a transparent container from the relay device.

FIG. 21B illustrates a method 2150 that may include the aspects of the method 2100 in FIG. 21A. As illustrated at 2102, the base station may receive an indication of the relay device or the remote device from a network, and the base station may transmit the configuration for the relay device or the remote device, at 2104, based on the indication from the network. The reception may be performed, e.g., by the network component 2244 of the apparatus 2202. FIG. 1 illustrates an example of a base station 102 or 180 having a connection to a core network.

As illustrated at 2105, the base station may receive an availability indication of logged MDT measurements from the remote device via the relay device. The reception of the availability indication may be performed, e.g., by the availability component 2246 of the apparatus 2202 in FIG. 22.

As illustrated at 2106, the base station may transmit a request for the logged MDT measurements to the relay device for the remote device. The transmission of the request may be performed, e.g., by the request component 2248 of the apparatus 2202 in FIG. 22. FIG. 8A illustrates an example of a base station receiving the availability indication and sending the request.

As illustrated at 2108, the base station may receive the logged MDT measurements from the remote device via the relay device. The reception may be performed, e.g., by the MDT report component 2242 in FIG. 22.

FIG. 22 is a diagram 2200 illustrating an example of a hardware implementation for an apparatus 2202. The apparatus 2202 may be a base station, a component of a base station, or may implement base station functionality. In some aspects, the apparatus 1802 may include a baseband unit 2204. The baseband unit 2204 may communicate through a cellular RF transceiver 2222 with the UE 104, the IAB node 111, etc. The baseband unit 2204 may include a computer-readable medium/memory. The baseband unit 2204 is responsible for general processing, including the execution of software stored on the computer-readable medium/memory. The software, when executed by the baseband unit 2204, causes the baseband unit 2204 to perform the various functions described supra. The computer-readable medium/memory may also be used for storing data that is manipulated by the baseband unit 2204 when executing software. The baseband unit 2204 further includes a reception component 2230, a communication manager 2232, and a transmission component 2234. The communication manager 2232 includes the one or more illustrated components. The components within the communication manager 2232 may be stored in the computer-readable medium/memory and/or configured as hardware within the baseband unit 2204. The baseband unit 2204 may be a component of the device 310 and may include the memory 376 and/or at least one of the TX processor 316, the RX processor 370, and the controller/processor 375.

The communication manager 2232 includes an MDT configuration component 2240 that transmits a configuration for MDT measurements of sidelink communication for at least one of a relay device or a remote device served by the relay device, e.g., as described in connection with 2104 of FIG. 21A or 21B. The communication manager 2232 further includes an MDT report component 2242 that is configured to receive the MDT measurements from the at least one of the relay device or the remote device based on the configuration, e.g., as described in connection with 2108 in FIG. 21A or 21B. The communication manager 2232 may further include a network component 2244 that is configured to receive an indication of the relay device or the remote device from a network, e.g., as described in connection with 2102 in FIG. 21B. The communication manager 2232 may further include an availability component 2246 that is configured to receive an availability indication of logged MDT measurements from a remote device, e.g., as described in connection with 2103 of FIG. 21B. The communication manager 2232 may further include a request component 2248 that is configured to transmit a request for the logged MDT measurements to the relay device for the remote device, e.g., as described in connection with 2106 in FIG. 21B.

The apparatus may include additional components that perform each of the blocks of the algorithm in the flowcharts of FIGS. 21A and/or 21B, as well as the aspects performed by the base station in any of FIGS. 5-8B, 14, or 15. As such, each block in the flowcharts of FIGS. 21A and/or 21B, as well as the aspects performed by the base station in any of FIGS. 5-8B, 14, or 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2202 may include a variety of components configured for various functions. In one configuration, the apparatus 2202, and in particular the baseband unit 2204, includes means for transmitting a configuration for MDT measurements of sidelink communication for at least one of a relay device or a remote device served by the relay device and means for receiving the MDT measurements from the at least one of the relay device or the remote device based on the configuration. The apparatus 2202 may further include means for receiving an indication of the relay device or the remote device from a network, wherein the base station transmits the configuration for the relay device or the remote device based on the indication from the network. The apparatus 2202 may further include means for receiving an availability indication of logged MDT measurements from the remote device via the relay device; means for transmitting a request for the logged MDT measurements to the relay device for the remote device; and means for receiving the logged MDT measurements from the remote device via the relay device. The means may be one or more of the components of the apparatus 2202 configured to perform the functions recited by the means. As described supra, the apparatus 2202 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication at a relay device configured to relay communication between a base station and a remote device, comprising: receiving, from the base station, a configuration for MDT measurements associated with sidelink communication; and transmitting a report of the MDT measurements to the base station based on the configuration.

In aspect 2, the method of aspect 1 further includes that the configuration is for a logged MDT procedure at the relay device when the relay device is in an RRC idle state or an RRC inactive state, the method further comprising: transitioning from an RRC connected state to the RRC idle state or the RRC inactive state; storing the MDT measurements associated with the sidelink communication; and transitioning to the RRC connected state prior to transmitting the report of the MDT measurements.

In aspect 3, the method of aspect 2 further includes that the configuration indicates one or more of: at least one sidelink transmission resource pool for the relay device to collect the MDT measurements when in the RRC idle state or the RRC inactive state, sidelink frequency information, a CBR measurement configuration, or an event trigger for collecting logged MDT measurements.

In aspect 4, the method of aspect 1 further includes that the configuration is for a logged MDT procedure at the remote device when the remote device is in an RRC idle state or an RRC inactive state, the method further comprising: receiving the MDT measurements from the remote device; and transmitting the MDT measurements from the remote device in the report to the base station.

In aspect 5, the method of aspect 4 further includes that the relay device transmits the MDT measurements from the remote device to the base station without storage.

In aspect 6, the method of aspect 4 or aspect 5 further includes that the MDT measurements from the remote device are comprised in a transparent container from the relay device to the base station.

In aspect 7, the method of any of aspects 4-6 further includes that the relay device receives the MDT measurements from multiple remote devices, the method further comprising: storing the MDT measurements from the multiple remote devices while in the RRC idle state or the RRC inactive state; and transitioning to an RRC connected state prior to transmitting the report, wherein the report comprises aggregate MDT measurements for the multiple remote devices.

In aspect 8, the method of any of aspects 1-7 further includes that the MDT measurements configured by the base station include one or more of: sidelink signal quantity measurement, a PDCP SDU data volume measurement for sidelink, an average UE throughput measurement for the sidelink, a packet delay measurement for the sidelink, or a packet loss rate measurement for the sidelink.

In aspect 9, the method of aspect 8 further includes that the report indicates the MDT measurements per SL-DRB and per remote device.

In aspect 10, the method of any of aspects 1-9 further includes that the MDT measurements configured by the base station include a measurement of a delay between the remote device and the relay device, the delay including at least one of a first queuing delay in a PDCP layer of the remote device, an air-interface delay between the remote device and the relay device and a second queuing delay in an ADAPT of the remote device or the relay device.

In aspect 11, the method of aspect 10 further includes measuring the delay between the remote device and the relay device per DRB for one or more remote device s, wherein the report to the base station includes an indication of the delay.

In aspect 12, the method of aspect 10 or aspect 11 further includes measuring the delay between the remote device and the relay device per sidelink RLC for one or more remote devices, wherein the report to the base station includes an indication of the delay per the sidelink RLC and a corresponding DRB ID.

In aspect 13, the method of any of aspects 1-12 further includes that the configuration indicates for the relay device or the remote device to report the MDT measurements for one or more sidelink transmission resource pools, the MDT measurements including at least one of a sidelink data volume, a sidelink average throughput, a sidelink packet delay, a sidelink packet loss, a SD-RSRP, and the configuration indicates for the MDT measurements to be associated with one or more of location information, an additional measurement of a different RAT than sidelink, or one or more sensor measurements.

In aspect 14, the method of aspect 13 further includes that the report of the MDT measurements is periodic or based on an occurrence of a trigger event.

In aspect 15, the method of aspect 13 or aspect 14 further includes skipping transmission of the location information or the additional measurement of the different RAT in the report based on the location information or the measurements of the different RAT being reported with inter-RAT or intra-RAT MDT measurements for Uu.

In aspect 16, the method of any of aspects 1-15 further includes that the relay device is a first UE, and the remote device is a second UE.

In aspect 17, the method of any of aspects 1-15 further includes that relay device is an IAB node, and the remote device is a UE or another IAB node.

Aspect 18 is an apparatus for wireless communication including at least one processor coupled to a memory, the memory and the at least one processor configured to perform the method of any of aspects 1 to 17.

In aspect 19, the apparatus of aspect 18 further includes at least one antenna coupled to the at least one processor.

In aspect 20, the apparatus of aspect 18 or 19 further includes a transceiver coupled to the at least one processor.

Aspect 21 is an apparatus for wireless communication including means for implementing any of aspects 1 to 17.

In aspect 22, the apparatus of aspect 21 further includes at least one antenna coupled to the means for implementing any of aspects 1 to 17.

In aspect 23, the apparatus of aspect 21 or 22 further includes a transceiver coupled to the means for implementing any of aspects 1 to 17.

Aspect 24 is a computer-readable medium storing computer executable code, where the code when executed by a processor causes the processor to implement any of aspects 1 to 17.

Aspect 25 is a method of wireless communication at a first UE, comprising: transmitting, to a second UE, a configuration for logged MDT measurements associated with sidelink communication; receiving an availability indication of logged MDT measurements from the second UE; transmitting a request for the logged MDT measurements to the second UE; and receiving the logged MDT measurements from the second UE over sidelink.

Aspect 26 is a method of wireless communication at a first wireless device, comprising: transmitting, to a second wireless device, a configuration for logged MDT measurements associated with sidelink communication; receiving an availability indication of logged MDT measurements from the second wireless device; transmitting a request for the logged MDT measurements to the second wireless device; and receiving the logged MDT measurements from the second wireless device over sidelink.

Aspect 27 is an apparatus for wireless communication including at least one processor coupled to a memory, the memory and the at least one processor configured to perform the method of aspect 25 or aspect 26.

In aspect 28, the apparatus of aspect 27 further includes at least one antenna coupled to the at least one processor.

In aspect 29, the apparatus of aspect 27 or 28 further includes a transceiver coupled to the at least one processor.

Aspect 30 is an apparatus for wireless communication including means for implementing aspect 25 or aspect 26.

In aspect 31, the apparatus of aspect 30 further includes at least one antenna coupled to the means for implementing aspect 25 or aspect 26.

In aspect 32, the apparatus of aspect 30 or 31 further includes a transceiver coupled to the means for implementing aspect 25 or aspect 26.

Aspect 33 is a computer-readable medium storing computer executable code, where the code when executed by a processor causes the processor to implement aspect 25 or aspect 26.

Aspect 34 is a method of wireless communication at a remote device, comprising: receiving, in a sidelink message from a relay device, a configuration for MDT measurements of sidelink communication; and transmitting the MDT measurements to the relay device.

In aspect 35, the method of aspect 34 further includes that the configuration indicates one or more of: at least one sidelink transmission resource pool for the remote device to collect the MDT measurements when in an RRC idle state or an RRC inactive state, sidelink frequency information, a CBR measurement configuration, or an event trigger for collecting logged MDT measurements.

In aspect 36, the method of aspect 34 or aspect 35 further includes transmitting an availability indication of the logged MDT measurements to the relay device; receiving a request for the logged MDT measurements from the relay device or from a base station via the relay device; and transmitting the logged MDT measurements to the relay device or to the base station via the relay device.

In aspect 37, the method of any of aspects 34-36 further include that the MDT measurements include one or more of: sidelink signal quantity measurement, a PDCP SDU data volume measurement for sidelink, an average UE throughput measurement for the sidelink, a packet delay measurement for the sidelink, or a packet loss rate measurement for the sidelink.

In aspect 38, the method of aspect 37 further includes that the MDT measurements are configured to be measured per SL-DRB.

In aspect 39, the method of any of aspects 34-38 further includes that the configuration indicates for the remote device to report the MDT measurements for one or more sidelink transmission resource pools, the MDT measurements including at least one of a sidelink data volume, a sidelink average throughput, a sidelink packet delay, a sidelink packet loss, a SD-RSRP, and the configuration indicates for the MDT measurements to be associated with one or more of location information, an additional measurement of a different RAT than sidelink, or one or more sensor measurements.

In aspect 40, the method of any of aspects 34-39 further includes that the relay device is a first UE, and the remote device is a second UE.

In aspect 41, the method of any of aspects 34-39 further includes that relay device is an IAB node, and the remote device is a UE or another IAB node.

Aspect 42 is an apparatus for wireless communication including at least one processor coupled to a memory, the memory and the at least one processor configured to perform the method of any of aspects 34-41.

In aspect 43, the apparatus of aspect 42 further includes at least one antenna coupled to the at least one processor.

In aspect 44, the apparatus of aspect 42 or 43 further includes a transceiver coupled to the at least one processor.

Aspect 45 is an apparatus for wireless communication including means for implementing any of aspects 34-41.

In aspect 46, the apparatus of aspect 45 further includes at least one antenna coupled to the means for implementing any of aspects 34-41.

In aspect 47, the apparatus of aspect 45 or 46 further includes a transceiver coupled to the means for implementing any of aspects 34-41.

Aspect 48 is a computer-readable medium storing computer executable code, where the code when executed by a processor causes the processor to implement any of aspects 34-41.

Aspect 49 is a method of wireless communication at a base station, comprising: transmitting a configuration for MDT measurements of sidelink communication for at least one of a relay device or a remote device served by the relay device; and receiving the MDT measurements from the at least one of the relay device or the remote device based on the configuration.

In aspect 50, the method of aspect 49 further includes that the configuration is for a logged MDT procedure at the relay device when the relay device is in an RRC idle state or an RRC inactive state.

In aspect 51, the method of aspect 49 or 50 further includes that the configuration indicates one or more of: at least one sidelink transmission resource pool for the relay device to collect the MDT measurements when in the RRC idle state or the RRC inactive state, sidelink frequency information, a CBR measurement configuration, an event trigger for collecting logged MDT measurements, sidelink signal quantity measurement, a PDCP SDU data volume measurement for sidelink, an average UE throughput measurement for the sidelink, a packet delay measurement for the sidelink, a packet loss rate measurement for the sidelink, a measurement of a delay between the remote device and the relay device, a queuing delay in an adaptation layer or a PDCP layer of the remote device or the relay device, a sidelink data volume, a sidelink average throughput, a sidelink packet delay, a sidelink packet loss, or a SD-RSRP.

In aspect 52, the method of any of aspects 49-51 further includes receiving an indication of the relay device or the remote device from a network, wherein the base station transmits the configuration for the relay device or the remote device based on the indication from the network.

In aspect 53, the method of any of aspects 49-52 further includes that the MDT measurements from the relay device comprise aggregate measurements and are received in response to an RRC connection with the relay device.

In aspect 54, the method of any of aspects 49-53 further includes that the configuration is for a logged MDT procedure at the remote device when the remote device is in a RRC idle state or an RRC inactive state, and the MDT measurements are from the remote device via the relay device.

In aspect 55, the method of aspect 54 further includes that the MDT measurements from the remote device are comprised in a transparent container from the relay device.

In aspect 56, the method of any of aspects 54 or 55 further includes receiving an availability indication of logged MDT measurements from the remote device via the relay device; transmitting a request for the logged MDT measurements to the relay device for the remote device; and receiving the logged MDT measurements from the remote device via the relay device.

In aspect 57, the method of any of aspects 49-56 further includes that the relay device is a first UE, and the remote device is a second UE.

In aspect 58, the method of any of aspects 49-56 further includes that relay device is an IAB node, and the remote device is a UE or another IAB node.

Aspect 59 is an apparatus for wireless communication including at least one processor coupled to a memory, the memory and the at least one processor configured to perform the method of any of aspects 49-58.

In aspect 60, the apparatus of aspect 59 further includes at least one antenna coupled to the at least one processor.

In aspect 61, the apparatus of aspect 59 or 60 further includes a transceiver coupled to the at least one processor.

Aspect 62 is an apparatus for wireless communication including means for implementing any of aspects 49-58.

In aspect 63, the apparatus of aspect 62 further includes at least one antenna coupled to the means for implementing any of aspects 49-58.

In aspect 64, the apparatus of aspect 62 or 63 further includes a transceiver coupled to the means for implementing any of aspects 49-58.

Aspect 65 is a computer-readable medium storing computer executable code, where the code when executed by a processor causes the processor to implement any of aspects 49-58.

what is claimed is:

1. An apparatus for wireless communication at a relay device configured to relay communication between a base station and a remote device, comprising:
memory; and
at least one processor coupled to the memory, the memory and the at least one processor configured to:
receive, from the base station, a configuration for minimization of drive test (MDT) measurements associated with sidelink communication; and
transmit a report of the MDT measurements to the base station based on the configuration.

2. The apparatus of claim 1, wherein the configuration is for a logged MDT procedure at the relay device when the relay device is in a radio resource control (RRC) idle state or an RRC inactive state, the memory and the at least one processor being further configured to:
transition from an RRC connected state to the RRC idle state or the RRC inactive state;
store the MDT measurements associated with the sidelink communication; and
transition to the RRC connected state prior to transmitting the report of the MDT measurements.

3. The apparatus of claim 2, wherein the configuration indicates one or more of:
at least one sidelink transmission resource pool for the relay device to collect the MDT measurements when in the RRC idle state or the RRC inactive state,
sidelink frequency information,
a channel busy ratio (CBR) measurement configuration, or
an event trigger for collecting logged MDT measurements.

4. The apparatus of claim 1, wherein the configuration is for a logged MDT procedure at the remote device when the remote device is in a radio resource control (RRC) idle state or an RRC inactive state, the memory and the at least one processor being further configured to:
receive the MDT measurements from the remote device; and
transmit the MDT measurements from the remote device in the report to the base station.

5. The apparatus of claim 4, wherein the relay device transmits the MDT measurements from the remote device to the base station without storage.

6. The apparatus of claim 4, wherein the MDT measurements from the remote device are comprised in a transparent container from the relay device to the base station.

7. The apparatus of claim 4, wherein the relay device receives the MDT measurements from multiple remote devices, the memory and the at least one processor being further configured to:
store the MDT measurements from the multiple remote devices while in the RRC idle state or the RRC inactive state; and
transition to an RRC connected state prior to transmitting the report, wherein the report comprises aggregate MDT measurements for the multiple remote devices.

8. The apparatus of claim 1, wherein the MDT measurements configured by the base station include one or more of:
sidelink signal quantity measurement,
a packet data convergence protocol (PDCP) service data unit (SDU) data volume measurement for sidelink,
an average UE throughput measurement for the sidelink,
a packet delay measurement for the sidelink, or
a packet loss rate measurement for the sidelink.

9. The apparatus of claim 8, wherein the report indicates the MDT measurements per Sidelink data radio bearer (SL-DRB) and per remote device.

10. The apparatus of claim 1, wherein the MDT measurements configured by the base station include a measurement of a delay between the remote device and the relay device, the delay including at least one of a first queuing delay in a packet data convergence protocol (PDCP) layer of the remote device, an air-interface delay between the remote device and the relay device and a second queuing delay in an Adaptation layer (ADAPT) of the remote device or the relay device.

11. The apparatus of claim 10, wherein the memory and the at least one processor are further configured to:
measure the delay between the remote device and the relay device per data radio bearer (DRB) for one or more remote device s, wherein the report to the base station includes an indication of the delay.

12. The apparatus of claim 10, wherein the memory and the at least one processor are further configured to:
measure the delay between the remote device and the relay device per sidelink radio link control (RLC) for one or more remote devices, wherein the report to the base station includes an indication of the delay per the sidelink RLC and a corresponding data radio bearer (DRB) identifier (ID).

13. The apparatus of claim 1, wherein the configuration indicates for the relay device or the remote device to report the MDT measurements for one or more sidelink transmission resource pools, the MDT measurements including at least one of a sidelink data volume, a sidelink average throughput, a sidelink packet delay, a sidelink packet loss, a sidelink discovery reference signal received power (SD-RSRP), and the configuration indicates for the MDT measurements to be associated with one or more of location information, an additional measurement of a different radio access technology (RAT) than sidelink, or one or more sensor measurements.

14. The apparatus of claim 13, wherein the report of the MDT measurements is periodic or based on an occurrence of a trigger event.

15. The apparatus of claim 13, wherein the memory and the at least one processor are further configured to:
skip transmission of the location information or the additional measurement of the different RAT in the report based on the location information or the measurements of the different RAT being reported with inter-RAT or intra-RAT MDT measurements for Uu.

16. An apparatus for wireless communication at a first wireless device, comprising:
memory; and
at least one processor coupled to the memory, the memory and the at least one processor configured to:
transmit, to a second wireless device, a configuration for logged minimization of drive test (MDT) measurements associated with sidelink communication;
receive an availability indication of logged MDT measurements from the second wireless device;
transmit a request for the logged MDT measurements to the second wireless device; and
receive the logged MDT measurements from the second wireless device over sidelink.

17. An apparatus for wireless communication at a remote device, comprising:
memory; and
at least one processor coupled to the memory, the memory and the at least one processor configured to:
receive, in a sidelink message from a relay device, a configuration for minimization of drive test (MDT) measurements of sidelink communication; and
transmit the MDT measurements to the relay device.

18. The apparatus of claim 17, wherein the configuration indicates one or more of:
at least one sidelink transmission resource pool for the remote device to collect the MDT measurements when in a radio resource control (RRC) idle state or an RRC inactive state,
sidelink frequency information,
a channel busy ratio (CBR) measurement configuration, or
an event trigger for collecting logged MDT measurements.

19. The apparatus of claim 18, wherein the memory and the at least one processor are further configured to:
transmit an availability indication of the logged MDT measurements to the relay device;
receive a request for the logged MDT measurements from the relay device or from a base station via the relay device; and
transmit the logged MDT measurements to the relay device or to the base station via the relay device.

20. The apparatus of claim 17, wherein the MDT measurements include one or more of:
sidelink signal quantity measurement,
a packet data convergence protocol (PDCP) service data unit (SDU) data volume measurement for sidelink,
an average UE throughput measurement for the sidelink,
a packet delay measurement for the sidelink, or
a packet loss rate measurement for the sidelink.

21. The apparatus of claim 20, wherein the MDT measurements are configured to be measured per Sidelink data radio bearer (SL-DRB).

22. The apparatus of claim 17, wherein the configuration indicates for the remote device to report the MDT measurements for one or more sidelink transmission resource pools, the MDT measurements including at least one of a sidelink data volume, a sidelink average throughput, a sidelink packet delay, a sidelink packet loss, a sidelink discovery reference signal received power (SD-RSRP), and the configuration indicates for the MDT measurements to be associated with one or more of location information, an additional measurement of a different radio access technology (RAT) than sidelink, or one or more sensor measurements.

23. An apparatus for wireless communication at a base station, comprising:
memory; and
at least one processor coupled to the memory, the memory and the at least one processor configured to:
transmit a configuration for minimization of drive test (MDT) measurements of sidelink communication for at least one of a relay device or a remote device served by the relay device; and
receive the MDT measurements from the at least one of the relay device or the remote device based on the configuration.

24. The apparatus of claim 23, wherein the configuration is for a logged MDT procedure at the relay device when the relay device is in a radio resource control (RRC) idle state or an RRC inactive state.

25. The apparatus of claim 24, wherein the configuration indicates one or more of:
at least one sidelink transmission resource pool for the relay device to collect the MDT measurements when in the RRC idle state or the RRC inactive state,
sidelink frequency information,
a channel busy ratio (CBR) measurement configuration,
an event trigger for collecting logged MDT measurements,
sidelink signal quantity measurement,
a packet data convergence protocol (PDCP) service data unit (SDU) data volume measurement for sidelink,
an average UE throughput measurement for the sidelink,
a packet delay measurement for the sidelink,
a packet loss rate measurement for the sidelink,
a measurement of a delay between the remote device and the relay device,
a queuing delay in an adaptation layer or a PDCP layer of the remote device or the relay device,
a sidelink data volume,
a sidelink average throughput,
a sidelink packet delay,
a sidelink packet loss, or
a sidelink discovery reference signal received power (SD-RSRP).

26. The apparatus of claim 23, wherein the memory and the at least one processor are further configured to:
receive an indication of the relay device or the remote device from a network, wherein the base station transmits the configuration for the relay device or the remote device based on the indication from the network.

27. The apparatus of claim 24, wherein the MDT measurements from the relay device comprise aggregate measurements and are received in response to an RRC connection with the relay device.

28. The apparatus of claim 23, wherein the configuration is for a logged MDT procedure at the remote device when the remote device is in a radio resource control (RRC) idle state or an RRC inactive state, and the MDT measurements are from the remote device via the relay device.

29. The apparatus of claim 28, wherein the MDT measurements from the remote device are comprised in a transparent container from the relay device.

30. The apparatus of claim 26, wherein the memory and the at least one processor are further configured to:
receive an availability indication of logged MDT measurements from the remote device via the relay device;
transmit a request for the logged MDT measurements to the relay device for the remote device; and
receive the logged MDT measurements from the remote device via the relay device.
